(19) United States
(12) Patent Application Publication
(10) Pub. No.: US 2023/0164582 A1
(43) Pub. Date: May 25, 2023

(54) Beam Sweep Order Change due to RACH

(71) Applicant: Telefonaktiebolaget LM Ericsson (publ), Stockholm (SE)

(72) Inventors: Ali Parichehrehteroujeni, Linköping (SE); Pradeepa Ramachandra, Linköping (SE); Angelo Centonza, Torrenueva Costa, Granada (ES); Pablo Soldati, Solna (SE); Marco Belleschi, Solna (SE)

(21) Appl. No.: 17/799,315

(22) PCT Filed: Feb. 14, 2021
(86) PCT No.: PCT/SE2021/050126

§ 371 Date: Aug. 12, 2022

Related U.S. Application Data
(60) Provisional application No. 62/975,783, filed on Feb. 13, 2020.

(51) Int. Cl. H04W 16/28; H04W 74/08

(52) U.S. Cl. CPC H04W 16/28; H04W 74/0841

(57) ABSTRACT

Embodiments herein relate to for example, a method performed by a first radio network node (12) for handling communication in a wireless communication network. The first radio network node (12) changes an order of beam sweeping for a served cell based on a detection of a RACH configuration conflict.

### TECHNICAL FIELD

Embodiments herein relate to a first and a second radio network node, and methods performed therein regarding communication in a wireless communication network. Furthermore, a computer program product and a computer-readable storage medium are also provided herein. Especially, embodiments herein relate to handling or enabling communication, e.g. handling access to the radio network node, in the wireless communication network.

### BACKGROUND

In a typical wireless communication network, user equipments (UE), also known as wireless communication devices, mobile stations, stations (STA) and/or wireless devices, communicate via a Radio access Network (RAN) to one or more core networks (CN). The RAN covers a geographical area which is divided into service areas or cells, with each service area or cell being served by a radio network node such as an access node e.g. a Wi-Fi access point or a radio base station (RBS), which in some radio access technologies (RAT) may also be called, for example, a NodeB, an evolved NodeB (eNodeB) and a gNodeB (gNB). The service area or cell area is a geographical area where radio coverage is provided by the radio network node. The radio network node operates on radio frequencies to communicate over an air interface with the UEs within range of the access node. The radio network node communicates over a downlink (DL) to the UE and the UE communicates over an uplink (UL) to the radio network node. The radio network node may be a distributed node comprising a remote radio unit and a separated baseband unit.

A Universal Mobile Telecommunications System (UMTS) is a third generation telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with UEs. In a forum known as the Third Generation Partnership Project (3GPP), telecommunications suppliers propose and agree upon standards for present and future generation networks and UTRAN specifically, and investigate enhanced data rate and radio capacity. In some RANs, e.g. as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3^{rd} Generation Partnership Project (3GPP) and this work continues in the coming 3GPP releases, such as 5G networks. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the Radio Access Network (RAN) of an EPS has an essentially “flat” architecture comprising radio network nodes connected directly to one or more core networks.

With the emerging 5G technologies also known as new radio (NR), the use of very many transmit- and receive-antenna elements is of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

Beamforming allows the signal to be stronger for an individual connection. On the transmit-side this may be achieved by a concentration of the transmitted power in the desired direction(s), and on the receive-side this may be achieved by an increased receiver sensitivity in the desired direction(s). This beamforming enhances throughput and coverage of the connection. It also allows reducing the interference from unwanted signals, thereby enabling several simultaneous transmissions over multiple individual connections using the same resources in the time-frequency grid, so-called multi-user Multiple Input Multiple Output (MIMO).

5G is the fifth generation of cellular technology and was introduced in Release 15 of the 3GPP standard. It is designed to increase speed, reduce latency, and improve flexibility of wireless services. The 5G system (5GS) includes both a new radio access network (NG-RAN) and a new core network (5GC).

5G is designed to support new use case requiring ultra-reliable low-latency communication (URLLC) such as factory automation and autonomous driving. To be able to meet the stringent requirements on reliability and latency also during mobility, two new handover types are introduced in 5G Release 16 called make-before-break handover and conditional handover. These will be described in more detail below after a review of the NG-RAN architecture and the legacy handover procedure.

Overview of the NG-RAN architecture.

Similar to E-UTRAN in 4G, the NG-RAN uses a flat architecture and consists of base stations, called gNBs, which are interconnected with each other by means of the Xn-interface. The gNBs are also connected by means of the NG interface to the 5GC, more specifically to the Access and Mobility Function (AMF) by the NG-C interface and to the User Plane Function (UPF) by means of the NG-U interface. The gNB in turn supports one or more cells which provides the radio access to the UE. The radio access technology, called NR, is orthogonal frequency division multiplexing (OFDM) based like in LTE and offers high data transfer speeds and low latency. Note that NR is sometimes used to refer to the whole 5G system although it is strictly speaking only the 5G radio access technology (RAT). The current 5G RAN (NG-RAN) architecture is depicted and described in TS 38.401 v15.5.0 and is shown in FIG. 1.

The NG architecture can be further described as follows:
The NG-RAN consists of a set of gNBs connected to the 5GC through the NG interface.
An gNB can support Frequency Division Duplex (FDD) mode, Time division duplex (TDD) mode or dual mode operation.
gNBs can be interconnected through the Xn interface.
A gNB may consist of a gNB-central unit (CU) and gNB-distributed units (DU). A gNB-CU and a gNB-DU are connected via the F1 logical interface.
One gNB-DU is connected to only one gNB-CU.

NOTE: For resiliency, a gNB-DU may be connected to multiple gNB-CU by appropriate implementation.

NG, Xn and F1 are logical interfaces. The NG-RAN is layered into a Radio Network Layer (RNL) and a Transport Network Layer (TNL). The NG-RAN architecture, i.e. the NG-RAN logical nodes and interfaces between them, is defined as part of the RNL. For each NG-RAN interface (e.g. NG, Xn, F1) the related TNL protocol and the functionality are specified. The TNL provides services for user plane transport, and signalling transport. If security protection for control plane and user plane data on TNL of NG-RAN interfaces have to be supported, Network Domain Security (NDS) and/or IP network layer security, see 3GPP TS 33.401 v.15.10.0, shall be applied.

A gNB may also be connected to an LTE eNB via the X2 interface. Another architectural option is that where an LTE eNB connected to the Evolved Packet Core network is connected over the X2 interface with a so called en-gNB. The latter is a gNB not connected directly to a CN and connected via X2 to an eNB for the sole purpose of performing dual connectivity.

The architecture in FIG. 1 can be expanded by splitting the gNB-CU into two entities. So in the split architecture option, the RAN protocol stack functionality is separated in different parts. The CU-control plane (CP) is expected to handle the radio resource control (RRC) layer, the CU-user plane (UP) will handle the Packet Data Convergence Protocol (PDCP) layer and the DU will handle the radio link control (RLC), medium access control (MAC) and physical (PHY) layer of the protocol stack. In some further split the DU may have a separated unit that handles the PHY layer parts separately compared to RLC and MAC layers that are handled in a DU.

FIG. 2 shows a split gNB architecture in NG RAN. As different units handle different protocol stack functionalities, there will be a need for inter-node communication between the DU, the CU-UP and the CU-CP. This is achieved via F1-C interface related to control plane signalling, via the F1-U interface related to user plane signalling for communication between CU and DU and via the E1 interface for communication between CU-UP and CU-CP.

The E1 interface is a logical interface. It supports the exchange of signalling information between the endpoints. From a logical standpoint, the E1 interface is a point-to-point interface between a gNB-CU-CP and a gNB-CU-UP. The E1 interface enables exchange of UE associated information and non-UE associated information. The E1 interface is a control interface and is not used for user data forwarding.

Optimization of the random access channel (RACH) configuration in cells is a Release 9 self-organizing network (SON) feature that is key to optimizing the system performance of a mobile network. A poorly configured RACH may result in higher call setup and handover delays due to frequent RACH collisions, or low preamble-detection probability and limited coverage. The amount of uplink resource reserved for RACH also affects the system capacity. Therefore, a network operator should carefully monitor that the RACH parameters are appropriately set, considering factors such as the RACH load, the uplink interference, the traffic patterns and the population under the cell coverage.

The RACH optimization feature facilitates automatic configuration of physical random access channel (PRACH) parameters, including the PRACH resource configuration, preamble root sequence and cyclic shift configuration, to avoid preamble collisions with neighbouring cells. The principle of this automatic configuration is similar to the automatic Physical cell ID (PCI) configuration SON feature: the PRACH configuration information is included in the ‘X2 Setup’ and ‘eNB Configuration Update’ procedures. Therefore, whenever a new eNodeB is initialized and learns about its neighbours via the automatic neighbour relationship (ANR) function, it can at the same time learn the neighbouring PRACH configurations. It can then select its own PRACH configuration to avoid conflicts with the neighbouring ones.

Whenever a conflict is identified, one of the cells should change its configuration, but the algorithm for selecting which cell should change and in what manner is not specified. The network operator may also combine PRACH self-optimization with manual configuration if necessary, but this is typically more prone to errors and more time consuming than automatic RACH optimization.

Reporting of RACH information and failures.

RACH resources configuration and allocation among different cells may be performed at network planning phase in a centralized fashion, e.g., by operations, administration and maintenance (OAM), or in a distributed fashion, e.g., by RAN node at gNB-CU and/or gNB-DU. Network may use UE assistance information in terms of RACH report for a performed RACH procedure.

However, the task becomes more complicated given that these factors may change dynamically. For example, if the antenna tilt is changed in a cell, it will affect the rates of call arrival and handover in this cell and the surrounding cells, and therefore the RACH load per preamble in all those cells. A change in transmission power settings or handover thresholds may have similar effects.

Whenever such a network configuration change happens, the RACH self-optimization feature should automatically make appropriate measurements of the RACH performance and usage in all the affected cells and determine any necessary updates of the RACH parameters.

RACH parameters that may then be adjusted are typically the following:
Split of RACH preambles between contention-free access (CFA), contention-based access with high payload, and contention-based access with low payload;
RACH back-off parameter value or the RACH transmission power ramping parameters;
Any other parameter may be adjusted if found useful by a network operator.

In the following, the signalling designed for RACH optimization over X2 logical interface will be discussed as well as RACH UE assistance information reporting mechanism in LTE. In addition, different types of the RACH procedures in NR will be described and some details on how the RACH procedure works will be explained.

RACH related signalling over X2 interface in LTE system.

Generally, a RAN node may trigger an analysis of the information reported by the UE internally or in coordination in other RAN nodes. In this regards, as a part of LTE solution, eNB PRACH configuration may be exchanged over X2 interface by leveraging eNB X2 Setup Request and eNB Configuration update signalling, where the PRACH Configuration information element (IE), shown in the following table, is contained in the Served Cell Information IE. This IE indicates the PRACH resources used in neighbour cell.

| | | IE type and | Semantics | | Assigned |
|---|---|---|---|---|---|
| IE/Group Name | Presence | reference | description | Criticality | Criticality |
| RootSequenceIndex | M | INTEGER | See section | — | — |
| | | (0 . . . 837) | 5.7.2. in | | |
| | | | TS 36.211 | | |
| | | | [10] | | |
| ZeroCorrelationZoneConfiguration | M | INTEGER | See section | — | — |
| | | (0 . . . 15) | 5.7.2. in | | |
| | | | TS 36.211 | | |
| | | | [10] | | |
| HighSpeedFlag | M | BOOLEAN | TRUE | — | — |
| | | | corresponds | | |
| | | | to | | |
| | | | Restricted | | |
| | | | set and | | |
| | | | FALSE to | — | — |
| | | | Unrestricted | | |
| | | | set. See | | |
| | | | section | | |
| | | | 5.7.2 in TS | | |
| | | | 36.211 | | |
| | | | [10] | | |
| PRACH- | M | INTEGER | See section | — | — |
| FrequencyOffset | | (0 . . . 94) | 5.7.1 of | | |
| | | | TS 36.211 | | |
| | | | [10] | | |
| PRACH- | O | INTEGER | Mandatory | — | — |
| ConfigurationIndex | | (0 . . . 63) | for TDD, | | |
| | | | shall not | | |
| | | | be present | | |
| | | | for FDD. | | |
| | | | See section | | |
| | | | 5.7.1. in | | |
| | | | TS 36.211 | | |
| | | | [10] | | |

Note that such information will be exchanged between RAN nodes with cells identified as neighbouring cells. Neighbouring cells may be identified by radio resource monitoring (RRM) measurements provided by UEs. Upon detection of a new neighbour a RAN node may request to set up an X2 interface or later update the configurations if changed. This will be accomplished as part of X2 Setup Request or eNB Configuration signalling which includes PRACH configuration as part of Served Cell Information information element (IE).

In addition to the above-mentioned mechanism to exchange RACH related configuration over X2 interface as part of X2 Setup and eNB Configuration update signals, a Uu based signalling has been defined to use a UE assistance information to detect the potential issues, and further enhance the RACH performance by performing finer optimization relying on the provided UE assistance information.

Log and reporting of UE assistance RACH information in LTE.

In LTE the report of RACH information when random access procedure is performed may be requested by the network via the UE Information procedure in RRC (see below), in the case where a RACH procedure was successful. That procedure is summarized below, as described in RRC specifications:

### 5.6.5 UE Information

FIG. 3 shows communication of the UE.
The UE information procedure is used by E-UTRAN to request the UE to report information.

### 5.6.5.2 Initiation

E-UTRAN initiates the procedure by sending the UEInformationRequest message. E-UTRAN should initiate this procedure only after successful security activation.
5.6.5.3 Reception of the UEInformationRequest message
Upon receiving the UEInformationRequest message, the UE shall, only after successful security activation:
1> if rach-ReportReq is set to true, set the contents of the rach-Report in the UEInformationResponse message as follows:
   2> set the numberOfPreamblesSent to indicate the number of preambles sent by MAC for the last successfully completed random access procedure;
   2> if contention resolution was not successful as specified in TS 36.321 [6] for at least one of the transmitted preambles for the last successfully completed random access procedure:
      3> set the contentionDetected to true;
   2> else:
      3> set the contentionDetected to false;
   . . .
1> else:
   2> submit the UEInformationResponse message to lower layers for transmission via SRB1;
UEInformationRequest
   The UEInformationRequest is the command used by E-UTRAN to retrieve information from the UE.
Signalling radio bearer: SRB1
RLC-SAP: AM
Logical channel: DCCH
Direction: E-UTRAN to UE

### UEInformationRequest Message

-- ASN1START

| | |
|---|---|
| UEInformationRequest-r9 ::= | SEQUENCE { |
| rrc-TransactionIdentifier | RRC-TransactionIdentifier, |
| criticalExtensions | CHOICE { |
| c1 | CHOICE { |
| ueInformationRequest-r9 | UEInformationRequest-r9-IEs, |

```
      spare3 NULL, spare2 NULL, spare1 NULL
    },
```

| | |
|---|---|
| criticalExtensionsFuture | SEQUENCE { } |

}
}

| | |
|---|---|
| UEInformationRequest-r9-IEs ::= | SEQUENCE { |
| rach-ReportReq-r9 | BOOLEAN |
| rlf-ReportReq-r9 | BOOLEAN |
| nonCriticalExtension | UEInformationRequest-v930-IEs OPTIONAL |

}
. . .
-- ASN1STOP

UEInformationResponse
   The UEInformationResponse message is used by the UE to transfer the information requested by the E-UTRAN.
Signalling radio bearer: SRB1 or SRB2 (when logged measurement information is included)
RLC-SAP: AM
Logical channel: DCCH
Direction: UE to E-UTRAN

### UEInformationResponse Message

-- ASN1START

| UEInformationResponse-r9 ::= | SEQUENCE { | |
|---|---|---|
| UEInormationResponse-r9-IEs ::= | SEQUENCE { | |
| rach-Report-r9 | SEQUENCE { | |
| numberOfPreamblesSent-r9 | NumberOfPreamblesSent-r11, | |
| contentionDetected-r9 | BOOLEAN | |
| } | | OPTIONAL, |
| rlf-Report-r9 | RLF-Report-r9 | OPTIONAL, |

| | |
|---|---|
| nonCriticalExtension | UEInformationResponse-v930-IEs OPTIONAL |

}

| | |
|---|---|
| NumberOfPreamblesSent-r11::= | INTEGER (1..200) |

-- ASN1STOP

### RACH Configuration in NR.

As in LTE, random access procedure is described in the NR MAC specifications and parameters are configured by RRC e.g. in system information or handover (RRCReconfiguration with reconfigurationWithSync). Random access is triggered in many different scenarios, for example, when the UE is in RRC_IDLE or RRC_INACTIVE and want to access a cell that is camping on (i.e. transition to RRC_CONNECTED).

In NR, RACH configuration is broadcasted in system information block 1 (SIB1), as part of the servingCellConfigCommon (with both DL and UL configurations), where the RACH configuration is within the uplinkConfigCommon. The exact RACH parameters are within what is called initialUplinkBWP, since this is the part of the UL frequency the UE shall access and search for RACH resources.

### RACH-ConfigGeneric Information Element

-- ASN1START
-- TAG-RACH-CONFIGGENERIC-START

| | |
|---|---|
| RACH-ConfigGeneric ::= | SEQUENCE { |
| prach-ConfigurationIndex | INTEGER (0..255), |
| msg1-FDM | ENUMERATED {one, two, four, eight}, |
| msg1-FrequencyStart | INTEGER (0..maxNrofPhysicalResourceBlocks-1), |
| zeroCorrelationZoneConfig | INTEGER(0..15), |
| preambleReceivedTargetPower | INTEGER (−202..−60), |
| preambleTransMax | ENUMERATED {n3, n4, n5, n6, n7, n8, n10, n20, n50, n100, |

n200},

| | |
|---|---|
| powerRampingStep | ENUMERATED {dB0, dB2, dB4, dB6}, |
| ra-ResponseWindow | ENUMERATED {sl1, sl2, sl4, sl8, sl10, sl20, sl40, sl80}, |

...
}
-- TAG-RACH-CONFIGGENERIC-STOP
-- ASN1STOP

### RACH-ConfigCommon Information Element

-- ASN1START
-- TAG-RACH-CONFIGCOMMON-START

| | |
|---|---|
| RACH-ConfigCommon ::= | SEQUENCE { |
| rach-ConfigGeneric | RACH-ConfigGeneric |
| totalNumberOfRA-Preambles | INTEGER (1..63) OPTIONAL, -- Need S |

| | |
|---|---|
| ssb-perRACH-OccasionAndCB-PreamblesPerSSB | CHOICE |
| oneEighth | ENUMERATED |

{n4, n8, n12, n16, n20, n24, n28, n32, n36, n40, n44, n48, n52, n56, n60, n64},

| | |
|---|---|
| oneFourth | ENUMERATED |

{n4, n8, n12, n16, n20, n24, n28, n32, n36, n40, n44, n48, n52, n56, n60, n64},

| | |
|---|---|
| oneHalf | ENUMERATED |

{n4, n8, n12, n16, n20, n24, n28, n32, n36, n40, n44, n48, n52, n56, n60, n64},

| | |
|---|---|
| one | ENUMERATED |

{n4, n8, n12, n16, n20, n24, n28, n32, n36, n40, n44, n48, n52, n56, n60, n64},

| | |
|---|---|
| two | ENUMERATED {n4, n8, n12, n16, n20, n24, n28, n32}, |
| four | INTEGER (1..16), |
| eight | INTEGER (1..8), |
| sixteen | INTEGER (1..4) |

}
OPTIONAL, -- Need M

| | |
|---|---|
| groupBconfigured | SEQUENCE { |
| ra-MSG3SizeGroupA | ENUMERATED {b56, b144, b208, b282, b480, b640, |

b800, b72, spare6, spare 5, spare4,

spare3, spare2, spare1},

| | |
|---|---|
| messagePowerOffsetGroupB | ENUMERATED { minusinfinity, dB0, dB5, dB8, dB10, |

dB12, dB15, dB18},

| | |
|---|---|
| numberOfRA-PreamblesGroupA | INTEGER (1..64) |

}
OPTIONAL, -- Need R

| | |
|---|---|
| ra-ContentionResolutionTimer | ENUMERATED { sf8, sf16, sf24, sf32, sf40, sf48 |

sf56, sf64},

| | |
|---|---|
| rsrp-ThresholdSSB | RSRP-Range |

OPTIONAL, -- Need R

| | |
|---|---|
| rsrp-ThresholdSSB-SUL | RSRP-Range |

OPTIONAL, -- Cond SUL

| | |
|---|---|
| prach-RootSequenceIndex | CHOICE { |

| | |
|---|---|
| 1839 | INTEGER (0..837), |
| 1139 | INTEGER (0..137), |

},

| | |
|---|---|
| msg1-SubcarrierSpacing | SubcarrierSpacing |

OPTIONAL, -- Cond L139

| | |
|---|---|
| restrictedSetConfig | ENUMERATED {unrestrictedSet, restrictedSetTypeA, |

restrictedSetTypeB},

| | |
|---|---|
| msg3-transformPrecoder | ENUMERATED {enabled} |

OPTIONAL, -- Need R
...
}
-- TAG-RACH-CONFIGCOMMON-STOP
-- ASN1STOP

### Contention-Based RACH (CBRA) in NR.

In LTE, the RACH report to assist the network to perform RACH optimization, contains an indication that collision was detected. With that information it is clear that at some point before that RACH procedure that has succeeded that same UE tried to access the network and happened to have a collision. In NR, a mechanism also exists for contention resolution for contention-based random access.

### RACH Partitioning Per Beam in NR.

In NR, random access resource selection needs to be performed within a cell depending on measurements performed on synchronization signal blocks (SSB) or channel state information-reference signals (CSI-RS). A cell in NR is basically defined by a set of these SSBs that may be transmitted in one, typical implementation for lower frequencies e.g. below 6 GHz, or multiple downlink beams, typical implementation for lower frequencies e.g. below 6 GHz. For the same cell, these SSBs carry the same physical cell identifier (PCI) and a master information block (MIB). For standalone operation, i.e., to support UEs camping on an NR cell, they also carry in system information block one (SIB1) the RACH configuration, which comprises a mapping between the detected SSB covering the UE at a given point in time and the PRACH configuration (e.g. time, frequency, preamble, etc.) to be used. For that, each of these beams may transmit its own SSB which may be distinguished by an SSB index.

The mapping between RACH resources and SSBs (or CSI-RS) is also provided as part of the RACH configuration, in RACH-ConfigCommon. Two parameters are relevant here:
#SSBs-per-PRACH-occasion: ⅛, ¼, ½, 1, 2, 8 or 16, which represents the number of SSBs per RACH occasion;
#CB-preambles-per-SSB preambles to each SS-block: within a RACH occasion, how many preambles are allocated;

In a first example, if the number of SSBs per RACH occasion is 1, and if the UE is under the coverage of a specific SSB e.g. SSB index 2, there will be a RACH occasion for that SSB index 2. If the UE moves and is now under the coverage of another specific SSB e.g. SSB index 5, there will be another RACH occasion for that SSB index 5 i.e. each SSB detected by a given UE would have its own RACH occasion. Hence, at the network side, upon detecting a preamble in a particular RACH occasion the network knows exactly which SSB the UE has selected and, consequently, which downlink beam is covering the UE, so that the network can continue the downlink transmission e.g. random access response (RAR), etc. That factor 1 is an indication that each SSB has its own RACH resource. i.e., a preamble detected there indicates to the network which SSB the UE has selection i.e. which DL beam the network should use to communicate with the UE, such as the one to send the RAR. FIG. 4 shows a beam sweep. Beam sweep refers to the order in which different beams are transmitted by the network node. In FIG. 4, the network node transmits the beam denoted by PSS/SSS-x/SSB index 0 first and then PSS/SSS-x/SSB index 1 and then PSS/SSS-x/SSB index 2 and so on and so forth. The suffix value of ‘0’, ‘1’ etc. at the end of ‘PSS/SSS-x/SSB index’ indicates the time instance when this beam forming vector is used by the network to transmit the PSS/SSS-x/SSB.

FIG. 5 shows resources allocated for SSB and PRACH. Note that each SS-block typically maps to multiple preambles, different cyclic shifts and Zadoff-Chu roots, within a PRACH occasion, so that it is possible to multiple different UEs in the same RACH occasions since they may be under the coverage of the same SSB. In a second example, shown below, the number of SSBs per RACH occasion is 2. Hence, a preamble received in that RACH occasion indicated to the network that one of the two beams are being selected by the UE. So either the network has means via implementation to distinguish these two beams and/or should perform a beam sweeping in the downlink by transmitting the RAR in both beams, either simultaneously or, transmitting in one, waiting for a response from the UE, and if absent, transmit in the other.

FIG. 6 shows resources allocated for SSB and PRACH. Assuming now that in the first attempt the UE has selected an SSB, based on measurements performed in that cell, transmitted with initial power a selected preamble associated to the PRACH resource mapped to the selected SSB, and has not received a RAR within the RAR time window. According to the specifications, the UE may still perform preamble re-transmission, i.e. maximum number of allowed transmissions not reached.

The contention resolution in NR is shown below as described in the MAC specifications, TS 38.321 v.15.6.0:

### 5.1.5 Contention Resolution

Once Msg3 is transmitted, the MAC entity shall:
1> start the ra-ContentionResolutionTimer and restart the ra-ContentionResolutionTimer at each HARQ retransmission in the first symbol after the end of the Msg3 transmission;
1> monitor the PDCCH while the ra-ContentionResolutionTimer is running regardless of the possible occurrence of a measurement gap;
1> if notification of a reception of a PDCCH transmission of the SpCell is received from lower layers:
   2> if the C-RNTI MAC CE was included in Msg3:
      3> if the Random Access procedure was initiated for beam failure recovery (as specified in subclause 5.17) and the PDCCH transmission is addressed to the C-RNTI; or
      3> if the Random Access procedure was initiated by a PDCCH order and the PDCCH transmission is addressed to the C-RNTI; or
      3> if the Random Access procedure was initiated by the MAC sublayer itself or by the RRC sublayer and the PDCCH transmission is addressed to the C-RNTI and contains a UL grant for a new transmission:
         4> consider this Contention Resolution successful;
         4> stop ra-ContentionResolutionTimer;
         4> discard the TEMPORARY_C-RNTI;
         4> consider this Random Access procedure successfully completed.
   2> else if the CCCH SDU was included in Msg3 and the PDCCH transmission is addressed to its TEMPORARY_C-RNTI:
      3> if the MAC PDU is successfully decoded:
         4> stop ra-ContentionResolutionTimer;
         4> if the MAC PDU contains a UE Contention Resolution Identity MAC CE; and
         4> if the UE Contention Resolution Identity in the MAC CE matches the CCCH SDU transmitted in Msg3:
         5> consider this Contention Resolution successful and finish the disassembly and demultiplexing of the MAC PDU;
         5> if this Random Access procedure was initiated for SI request:
         6> indicate the reception of an acknowledgement for SI request to upper layers. 5> else:
         6> set the C-RNTI to the value of the TEMPORARY_C-RNTI;
         5> discard the TEMPORARY_C-RNTI;
         5> consider this Random Access procedure successfully completed.
         4> else:
         5> discard the TEMPORARY_C-RNTI;
         5> consider this Contention Resolution not successful and discard the successfully decoded MAC PDU.
1> if ra-ContentionResolutionTimer expires:
   2> discard the TEMPORARY_C-RNTI;
   2> consider the Contention Resolution not successful.
1> if the Contention Resolution is considered not successful:
   2> flush the HARQ buffer used for transmission of the MAC PDU in the Msg3 buffer;
   2> increment PREAMBLE_TRANSMISSION COUNTER by 1;
   2> if PREAMBLE_TRANSMISSION_COUNTER=preambleTransMax+1:
      3> indicate a Random Access problem to upper layers.
      3> if this Random Access procedure was triggered for SI request:
         4> consider the Random Access procedure unsuccessfully completed.
   2> if the Random Access procedure is not completed:
      3> select a random backoff time according to a uniform distribution between 0 and the PREAMBLE_BACKOFF;
      3> if the criteria (as defined in subclause 5.1.2) to select contention-free Random Access Resources is met during the backoff time:
         4> perform the Random Access Resource selection procedure (see subclause 5.1.2);
      3> else:
         4> perform the Random Access Resource selection procedure (see subclause 5.1.2) after the backoff time.

### 5.1.2 Random Access Resource Selection

The MAC entity shall:
1> if the Random Access procedure was initiated for beam failure recovery (as specified in subclause 5.17); and
1> if the beamFailureRecoveryTimer (in subclause 5.17) is either running or not configured; and
1> if the contention-free Random Access Resources for beam failure recovery request associated with any of the SSBs and/or CSI-RSs have been explicitly provided by RRC; and
1> if at least one of the SSBs with SS-RSRP above rsrp-ThresholdSSB amongst the SSBs in candidateBeamRSList or the CSI-RSs with CSI-RSRP above rsrp-ThresholdCSI-RS amongst the CSI-RSs in candidateBeamRSList is available:
   2> select an SSB with SS-RSRP above rsrp-ThresholdSSB amongst the SSBs in candidateBeamRSList or a CSI-RS with CSI-RSRP above rsrp-ThresholdCSI-RS amongst the CSI-RSs in candidateBeamRSList;
   2> if CSI-RS is selected, and there is no ra-PreambleIndex associated with the selected CSI-RS:
      3> set the PREAMBLE_INDEX to a ra-PreambleIndex corresponding to the SSB in candidateBeamRSList which is quasi-colocated with the selected CSI-RS as specified in TS 38.214 [7].
   2> else:
      3> set the PREAMBLE_INDEX to a ra-PreambleIndex corresponding to the selected SSB or CSI-RS from the set of Random Access Preambles for beam failure recovery request.
1> else if the ra-PreambleIndex has been explicitly provided by PDCCH; and
1> if the ra-PreambleIndex is not 0b000000:
   2> set the PREAMBLE_INDEX to the signalled ra-PreambleIndex;
   2> select the SSB signalled by PDCCH.
1> else if the contention-free Random Access Resources associated with SSBs have been explicitly provided in rach-ConfigDedicated and at least one SSB with SS-RSRP above rsrp-ThresholdSSB amongst the associated SSBs is available:
   2> select an SSB with SS-RSRP above rsrp-ThresholdSSB amongst the associated SSBs;
   2> set the PREAMBLE_INDEX to a ra-PreambleIndex corresponding to the selected SSB.
1> else if the contention-free Random Access Resources associated with CSI-RSs have been explicitly provided in rach-ConfigDedicated and at least one CSI-RS with CSI-RSRP above rsrp-ThresholdCSI-RS amongst the associated CSI-RSs is available:
   2> select a CSI-RS with CSI-RSRP above rsrp-ThresholdCSI-RS amongst the associated CSI-RSs;
   2> set the PREAMBLE_INDEX to a ra-PreambleIndex corresponding to the selected CSI-RS.
1> else if the Random Access procedure was initiated for SI request (as specified in TS 38.331 [5]); and
1> if the Random Access Resources for SI request have been explicitly provided by RRC:
   2> if at least one of the SSBs with SS-RSRP above rsrp-ThresholdSSB is available:
      3> select an SSB with SS-RSRP above rsrp-ThresholdSSB.
   2> else:
      3> select any SSB.
   2> select a Random Access Preamble corresponding to the selected SSB, from the Random Access Preamble(s) determined according to ra-PreambleStartIndex as specified in TS 38.331 [5];
   2> set the PREAMBLE_INDEX to selected Random Access Preamble.
1> else (i.e. for the contention-based Random Access preamble selection):
   2> if at least one of the SSBs with SS-RSRP above rsrp-ThresholdSSB is available:
      3> select an SSB with SS-RSRP above rsrp-ThresholdSSB.
   2> else:
      3> select any SSB.

### 5.1.3 Random Access Preamble Transmission

The MAC entity shall, for each Random Access Preamble:
1> if PREAMBLE_TRANSMISSION COUNTER is greater than one; and
1> if the notification of suspending power ramping counter has not been received from lower layers; and
1> if SSB or CSI-RS selected is not changed from the selection in the last Random Access Preamble transmission:
   2> increment PREAMBLE_POWER_RAMPING_COUNTER by 1.
1> select the value of DELTA_PREAMBLE according to subclause 7.3;
1> set PREAMBLE_RECEIVED_TARGET_POWER to preambleReceivedTargetPower+DELTA_PREAMBLE+(PREAMBLE_POWER_RAMPING_COUNTER−1)×PREAMBLE_POWER_RAMPING_STEP;
1> except for contention-free Random Access Preamble for beam failure recovery request, compute the RA-RNTI associated with the PRACH occasion in which the Random Access Preamble is transmitted;
1> instruct the physical layer to transmit the Random Access Preamble using the selected PRACH occasion, corresponding RA-RNTI (if available), PREAMBLE_INDEX and PREAMBLE_RECEIVED_TARGET_POWER.
   The RA-RNTI associated with the PRACH occasion in which the Random Access Preamble is transmitted, is computed as:

RA-RNTI=1+s_id+14×t_id+14×80×f_id+14×80×8×ul_carrier_id

where s_id is the index of the first OFDM symbol of the PRACH occasion (0≤s_id<14), t_id is the index of the first slot of the PRACH occasion in a system frame (0≤t_id<80), f_id is the index of the PRACH occasion in the frequency domain (0≤f_id<8), and ul_carrier_id is the UL carrier used for Random Access Preamble transmission (0 for NUL carrier, and 1 for SUL carrier).

### 5.1.4 Random Access Response Reception

Once the Random Access Preamble is transmitted and regardless of the possible occurrence of a measurement gap, the MAC entity shall:
1> if the contention-free Random Access Preamble for beam failure recovery request was transmitted by the MAC entity:
   2> start the ra-Response Window configured in BeamFailureRecoveryConfig at the first PDCCH occasion as specified in TS 38.213 [6] from the end of the Random Access Preamble transmission;
   2> monitor for a PDCCH transmission on the search space indicated by recoverySearchSpaceId of the SpCell identified by the C-RNTI while ra-Response Window is running
1> else:
   2> start the ra-Response Window configured in RACH-ConfigCommon at the first PDCCH occasion as specified in TS 38.213 [6] from the end of the Random Access Preamble transmission;
   2> monitor the PDCCH of the SpCell for Random Access Response(s) identified by the RA-RNTI while the ra-Response Window is running.
1> if notification of a reception of a PDCCH transmission on the search space indicated by recoverySearchSpaceId is received from lower layers on the Serving Cell where the preamble was transmitted; and
1> if PDCCH transmission is addressed to the C-RNTI; and
1> if the contention-free Random Access Preamble for beam failure recovery request was transmitted by the MAC entity:
   2> consider the Random Access procedure successfully completed.
1> else if a downlink assignment has been received on the PDCCH for the RA-RNTI and the received TB is successfully decoded:
   2> if the Random Access Response contains a MAC subPDU with Backoff Indicator:
      3> set the PREAMBLE_BACKOFF to value of the BI field of the MAC subPDU using Table 7.2-1, multiplied with SCALING_FACTOR_BI.
   2> else:
      3> set the PREAMBLE_BACKOFF to 0 ms.
   2> if the Random Access Response contains a MAC subPDU with Random Access Preamble identifier corresponding to the transmitted PREAMBLE_INDEX (see subclause 5.1.3):
      3> consider this Random Access Response reception successful.
   2> if the Random Access Response reception is considered successful:
      3> if the Random Access Response includes a MAC subPDU with RAPID only:
         4> consider this Random Access procedure successfully completed;
         4> indicate the reception of an acknowledgement for SI request to upper layers.
      3> else:
         4> apply the following actions for the Serving Cell where the Random Access Preamble was transmitted:
         5> process the received Timing Advance Command (see subclause 5.2);
         5> indicate the preambleReceivedTargetPower and the amount of power ramping applied to the latest Random Access Preamble transmission to lower layers (i.e. (PREAMBLE_POWER_RAMPING_COUNTER−1)×PREAMBLE_POWER_RAMPING_STEP);
         5> if the Serving Cell for the Random Access procedure is SRS-only SCell:
         6> ignore the received UL grant.
         5> else:
         6> process the received UL grant value and indicate it to the lower layers.
         4> if the Random Access Preamble was not selected by the MAC entity among the contention-based Random Access Preamble(s):
         5> consider the Random Access procedure successfully completed. 4> else:
         5> set the TEMPORARY_C-RNTI to the value received in the Random Access Response;
         5> if this is the first successfully received Random Access Response within this Random Access procedure:
         6> if the transmission is not being made for the CCCH logical channel:
         7> indicate to the Multiplexing and assembly entity to include a C-RNTI MAC CE in the subsequent uplink transmission.
         6> obtain the MAC PDU to transmit from the Multiplexing and assembly entity and store it in the Msg3 buffer.
            NOTE: If within a Random Access procedure, an uplink grant provided in the Random Access Response for the same group of contention-based Random Access Preambles has a different size than the first uplink grant allocated during that Random Access procedure, the UE behavior is not defined.
1> if ra-Response Window configured in BeamFailureRecoveryConfig expires and if a PDCCH transmission on the search space indicated by recoverySearchSpaceId addressed to the C-RNTI has not been received on the Serving Cell where the preamble was transmitted; or
1> if ra-Response Window configured in RACH-ConfigCommon expires, and if the Random Access Response containing Random Access Preamble identifiers that matches the transmitted PREAMBLE INDEX has not been received:
   2> consider the Random Access Response reception not successful;
   2> increment PREAMBLE_TRANSMISSION COUNTER by 1;
   2> if PREAMBLE_TRANSMISSION_COUNTER=preambleTransMax+1:
      3> if the Random Access Preamble is transmitted on the SpCell:
         4> indicate a Random Access problem to upper layers;
         4> if this Random Access procedure was triggered for SI request:
         5> consider the Random Access procedure unsuccessfully completed.
      3> else if the Random Access Preamble is transmitted on a SCell:
         4> consider the Random Access procedure unsuccessfully completed.
   2> if the Random Access procedure is not completed:
      3> select a random backoff time according to a uniform distribution between 0 and the PREAMBLE_BACKOFF;
      3> if the criteria (as defined in subclause 5.1.2) to select contention-free Random Access Resources is met during the backoff time:
         4> perform the Random Access Resource selection procedure (see subclause 5.1.2);
      3> else:
         4> perform the Random Access Resource selection procedure (see subclause 5.1.2) after the backoff time.
            The MAC entity may stop ra-Response Window (and hence monitoring for Random Access Response(s)) after successful reception of a Random Access Response containing Random Access Preamble identifiers that matches the transmitted PREAMBLE_INDEX. HARQ operation is not applicable to the Random Access Response reception.
            1.1.1 Contention-Free Random Access (CFRA) in NR and fallback to CBRA
            In NR, as in LTE, the UE may be configured to perform CFRA e.g. during handovers. That configuration goes in the reconfigurationWithSync of IE ReconfigurationWithSync (which goes in the CellGroupConfig IE, transmitted in the RRCReconfiguration message), as shown below:

| | |
|---|---|
| ReconfigurationWithSync ::= | SEQUENCE { |
| spCellConfigCommon | ServingCellConfigCommon |
| OPTIONAL, -- Need M | |
| newUE-Identity | RNTI-Value |
| t304 | ENUMERATED {ms50, ms100, ms150, ms200, ms500, ms1000, |
| ms2000, ms10000}, | |
| rach-ConfigDedicated | CHOICE { |
| uplink | RACH-ConfigDedicated, |
| supplementaryUplink | RACH-ConfigDedicated |
| } | |
| OPTIONAL, -- Need N | |
| ..., | |
| [[ | |
| smtc | SSB-MTC |
| OPTIONAL -- Need S | |
| ]] | |
| } | |

### RACH-ConfigDedicated Information Element

RACH-ConfigDedicated information element

-- ASN1START
-- TAG-RACH-CONFIG-DEDICATED-START

| | |
|---|---|
| RACH-ConfigDedicated ::= | SEQUENCE { |
| cfra | CFRA OPTIONAL, -- Need S |
| ra-Prioritization | RA-Prioritization |

OPTIONAL, -- Need N
...
}

| | |
|---|---|
| CFRA ::= | SEQUENCE { |
| occasions | SEQUENCE { |
| rach-ConfigGeneric | RACH-ConfigGeneric |
| ssb-perRACH-Occasion | ENUMERATED {oneEighth, oneFourth, oneHalf, one, two, |

four, eight, sixteen} OPTIONAL -- Cond SSB-CFRA
}
OPTIONAL, -- Need S

| | |
|---|---|
| resources | CHOICE { |
| ssb | SEQUENCE { |
| ssb-ResourceList | SEQUENCE (SIZE(1..maxRA-SSB-Resources)) OF CFRA-SSB- |

Resource,

| | |
|---|---|
| ra-ssb-OccasionMaskIndex | INTEGER (0..15) |

},

| | |
|---|---|
| csirs | SEQUENCE { |
| csirs-ResourceList | SEQUENCE (SIZE(1..maxRA-CSIRS-Resources)) of CFRA- |

CSIRS-Resource,

| | |
|---|---|
| rsrp-ThresholdCSI-RS | RSRP-Range |

```
    }
  },
  ...,
  [[
  totalNumberOfRA-Preambles-v1530 INTEGER (1..63) OPTIONAL --
Cond Occasions
  ]]
}
```

| | |
|---|---|
| CFRA-SSB-Resource ::= | SEQUENCE { |
| ssb | SSB-Index |
| ra-PreambleIndex | INTEGER (0..63), |

...
}

| | |
|---|---|
| CFRA-CSIRS-Resource ::= | SEQUENCE { |
| csi-RS | CSI-RS-Index, |
| ra-OccasionList | SEQUENCE (SIZE(1..maxRA-OccasionsPerCSIRS)) OF INTEGER |

(0..maxRA-Occasions-1),

| | |
|---|---|
| ra-PreambleIndex | INTEGER (0..63), |

...
}
-- TAG-RACH-CONFIG-DEDICATED-STOP
-- ASN1STOP

One first different shown above, that is already highlighted in the section 2.1.5 is that RACH resources may be mapped to beams, e.g. SSBs or CSI-RS resources that may be measured by the UE. Hence, when CFRA resources are provided they are also mapped to beams and there may be done only for a subset of beams in a given target cell.

The consequence is that to use CFRA resources the UE needs to select a beam for which it has CFRA resources configured in the dedicated configuration. In the case of SSBs, for example, that may be found in the ssb-ResourceList which is a SEQUENCE (SIZE(1 . . . maxRA-SSB-Resources)) OF CFRA-SSB-Resource.

In an analogy with LTE, i.e., if the NR solution would have been the same as LTE, upon selecting a beam with CFRA resource, e.g. a beam from the configured list, and not receiving the RAR, the UE would keep selecting the same resource and ramp the power before retransmitting the preamble. However, as in the case of NR CBRA, the UE has the option upon every failed attempt to select another beam. And, that another beam may either be in the list of beams for CFRA or it may not. In the case the selected beam is not, the UE performs CBRA.

Also notice that there is a fallback between CSI-RS selection to SSB selection, in case CFRA is provided for CSI-RS resources.

That is shown below, as captured in the MAC specifications (TS 38.331 v.15.10.0):

### 5.1.2 Random Access Resource Selection

The MAC entity shall:
1> if the Random Access procedure was initiated for beam failure recovery (as specified in subclause 5.17); and
1> if the beamFailureRecoveryTimer (in subclause 5.17) is either running or not configured; and
1> if the contention-free Random Access Resources for beam failure recovery request associated with any of the SSBs and/or CSI-RSs have been explicitly provided by RRC; and
1> if at least one of the SSBs with SS-RSRP above rsrp-ThresholdSSB amongst the SSBs in candidateBeamRSList or the CSI-RSs with CSI-RSRP above rsrp-ThresholdCSI-RS amongst the CSI-RSs in candidateBeamRSList is available:
   2> select an SSB with SS-RSRP above rsrp-ThresholdSSB amongst the SSBs in candidateBeamRSList or a CSI-RS with CSI-RSRP above rsrp-ThresholdCSI-RS amongst the CSI-RSs in candidateBeamRSList;
   2> if CSI-RS is selected, and there is no ra-PreambleIndex associated with the selected CSI-RS:
      3> set the PREAMBLE_INDEX to a ra-PreambleIndex corresponding to the SSB in candidateBeamRSList which is quasi-colocated with the selected CSI-RS as specified in TS 38.214 [7].
   2> else:
      3> set the PREAMBLE_INDEX to a ra-PreambleIndex corresponding to the selected SSB or CSI-RS from the set of Random Access Preambles for beam failure recovery request.
1> else if the ra-PreambleIndex has been explicitly provided by PDCCH; and
1> if the ra-PreambleIndex is not 0b000000:
   2> set the PREAMBLE_INDEX to the signalled ra-PreambleIndex;
   2> select the SSB signalled by PDCCH.
1> else if the contention-free Random Access Resources associated with SSBs have been explicitly provided in rach-ConfigDedicated and at least one SSB with SS-RSRP above rsrp-ThresholdSSB amongst the associated SSBs is available:
   2> select an SSB with SS-RSRP above rsrp-ThresholdSSB amongst the associated SSBs;
   2> set the PREAMBLE_INDEX to a ra-PreambleIndex corresponding to the selected SSB.
1> else if the contention-free Random Access Resources associated with CSI-RSs have been explicitly provided in rach-ConfigDedicated and at least one CSI-RS with CSI-RSRP above rsrp-ThresholdCSI-RS amongst the associated CSI-RSs is available:
   2> select a CSI-RS with CSI-RSRP above rsrp-ThresholdCSI-RS amongst the associated CSI-RSs;
   2> set the PREAMBLE_INDEX to a ra-PreambleIndex corresponding to the selected CSI-RS.
1> else if the Random Access procedure was initiated for SI request (as specified in TS 38.331 [5]); and
1> if the Random Access Resources for SI request have been explicitly provided by RRC:
   2> if at least one of the SSBs with SS-RSRP above rsrp-ThresholdSSB is available:
      3> select an SSB with SS-RSRP above rsrp-ThresholdSSB.
   2> else:
      3> select any SSB.
   2> select a Random Access Preamble corresponding to the selected SSB, from the Random Access Preamble(s) determined according to ra-PreambleStartIndex as specified in TS 38.331 [5];
   2> set the PREAMBLE_INDEX to selected Random Access Preamble.
1> else (i.e. for the contention-based Random Access preamble selection):
   2> if at least one of the SSBs with SS-RSRP above rsrp-ThresholdSSB is available:
      3> select an SSB with SS-RSRP above rsrp-ThresholdSSB.
   2> else:
      3> select any SSB.
1> if the Random Access procedure was initiated for SI request (as specified in TS 38.331 [5]); and
   1> if ra-AssociationPeriodIndex and si-RequestPeriod are configured:

The NR RAT, part of the NG RAN system, has a new structure for the configuration of RACH resources and processes when compared to LTE. In NR RACH resources and processes can be configured on a per beam basis. Cell beams are characterized by specific reference signals and communication channels. Typically, beams signals and channels are not always available in time for a given coverage area. The reason for this is that beams “sweep”, namely their availability in terms of reference signal (RS) and communication channels changes in the time and spatial domain given that the beam orientation is swept across a pre-set coverage area. Furthermore, the split architecture followed in NR and in other RATs such as E-UTRAN, implies that information needed to perform RACH optimization, such as RACH configurations of cells within a neighbourhood, indications on whether a possible RACH configuration conflict exists, indication of changes of RACH configuration to solve a RACH configuration conflict, need to be exchanged between e.g. the gNB-CU and gNB-DU, in the specific example of NR, or in general between the CU and the DU of the specific high layer split architecture for that RAT.

Exchanging RACH configuration information of the neighbouring cells in particular in frequency range 2 (FR2) with more than hundreds of neighbouring cells may come with a cumbersome effort for the DUs to decode the abstract syntax notation (ASN.1) and store/process such information in their own memory. Therefore, any solution that could limit the amount of the exchange information among the neighbouring cells may be beneficial for the radio network nodes.

### SUMMARY

An object of embodiments herein is to provide a mechanism that handles communication in the wireless communication network in an efficient and improved manner.

According to an aspect the object is achieved by providing a method performed by a first radio network node for handling communication in a wireless communication network. The first radio network node changes an order of beam sweeping for a served cell based on a detection of a RACH configuration conflict.

According to another aspect the object is achieved by providing a method performed by a second radio network node for handling communication in a wireless communication network. The second radio network node receives, from a first radio network node, an indication of a new order of beam sweeping for a served cell of the first radio network node. The second radio network node further performs a communication action based on the received indication.

According to yet another aspect the object is achieved by providing a first radio network node for handling communication in a wireless communication network. The first radio network node is configured to change an order of beam sweeping for a served cell based on a detection of a RACH configuration conflict.

According to still another aspect the object is achieved by providing a second radio network node for handling communication in a wireless communication network. The second radio network node is configured to receive a new order of beam sweeping for a served cell of a first radio network node. The second radio network node is configured to perform a communication action based on the received indication.

It is furthermore provided herein a computer program product comprising instructions, which, when executed on at least one processor, cause the at least one processor to carry out any of the methods above, as performed by the first or second radio network node, respectively. It is additionally provided herein a computer-readable storage medium, having stored thereon a computer program product comprising instructions which, when executed on at least one processor, cause the at least one processor to carry out the method according to any of the methods above, as performed by the first or second radio network node, respectively.

Embodiments herein disclose a method resolving RACH configuration conflicts between neighbouring cells, potentially without PRACH configuration information of neighbouring cells, in, for example, a split RAN architecture wherein a gNB central unit (gNB-CU), i.e. the second radio network node, is connected to multiple gNB distributed units (gNB-DUs) i.e. the first radio network node and a third radio network node, and each gNB-DU serves or controls one or more cells. Multiple gNB-CUs may also be connected to each other via Xn or NG interfaces. A RACH configuration conflict may occur either between two cells served by different gNB-DUs connected to the same gNB-CU or between two cells served by different gNB-DUs connected to different gNB-CUs. By changing the order of beam sweeping the conflict is avoided and communication is improved in the wireless communication network.

### BRIEF DESCRIPTION OF THE DRAWINGS

Embodiments will now be described in more detail in relation to the enclosed drawings, in which:

FIG. 1 is a schematic overview depicting a NG-RAN architecture according to prior art;

FIG. 2 is a schematic overview depicting a network node architecture according to prior art;

FIG. 3 is a schematic overview depicting a signalling scheme according to prior art;

FIG. 4 is a schematic overview depicting a beam sweeping process according to prior art;

FIG. 5 is a schematic overview depicting radio resources according to prior art;

FIG. 6 is a schematic overview depicting radio resources according to prior art;

FIG. 7 is a schematic overview depicting a wireless communication network according to embodiments herein;

FIG. 8 is a schematic overview depicting a flowchart at first radio network node according to some embodiments herein;

FIG. 9 is a schematic overview depicting a flowchart at a second radio network node according to some embodiments herein;

FIG. 10a is a schematic combined flowchart and signalling scheme according to some embodiments herein;

FIG. 10b is a schematic combined flowchart and signalling scheme according to some embodiments herein;

FIG. 10c is a schematic overview depicting an example according to some embodiments herein;

FIG. 10d is a schematic combined flowchart and signalling scheme according to some embodiments herein;

FIG. 10e is a schematic combined flowchart and signalling scheme according to some embodiments herein;

FIG. 10f is a schematic combined flowchart and signalling scheme according to some embodiments herein;

FIG. 11 is a schematic flowchart depicting a method performed by a first radio network node according to some embodiments herein;

FIG. 12 is a schematic flowchart depicting a method performed by a second radio network node according to some embodiments herein;

FIG. 13a is a block diagram depicting a first radio network node according to some embodiments herein;

FIG. 13b is a block diagram depicting a second radio network node according to some embodiments herein;

FIG. 14 schematically illustrates a telecommunication network connected via an intermediate network to a host computer;

FIG. 15 is a generalized block diagram of a host computer communicating via a base station with a user equipment over a partially wireless connection; and

FIGS. 16-19 are flowcharts illustrating methods implemented in a communication system including a host computer, a base station and a user equipment.

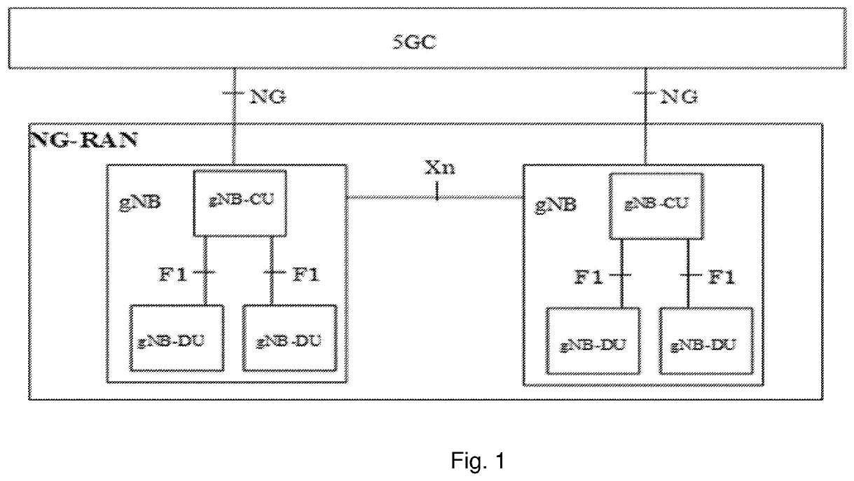

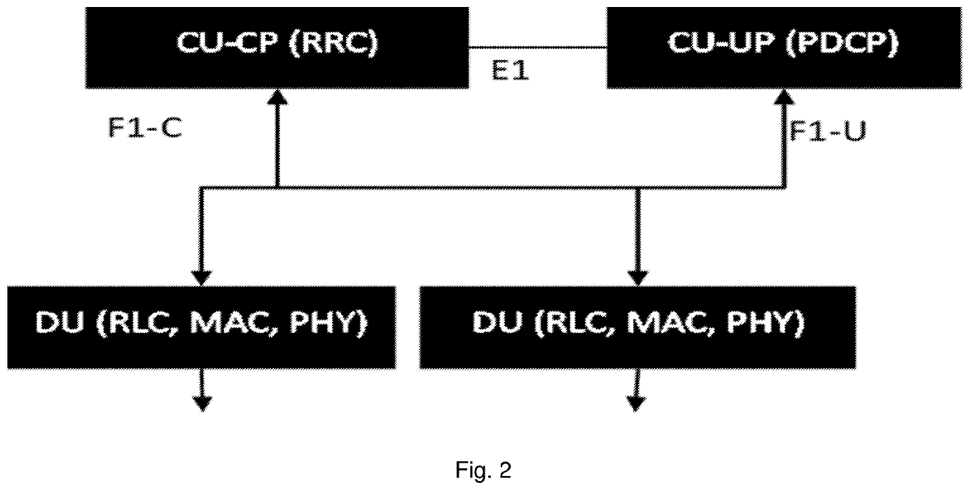

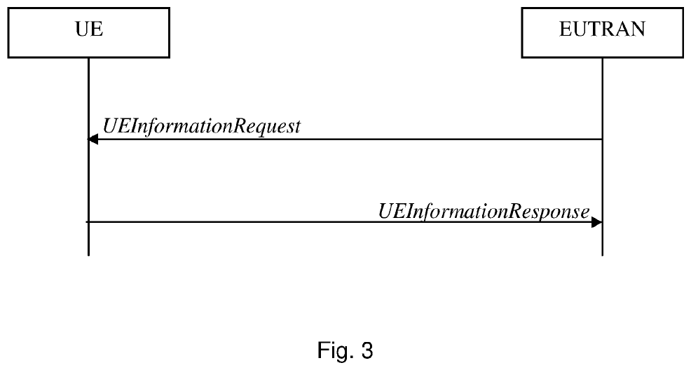

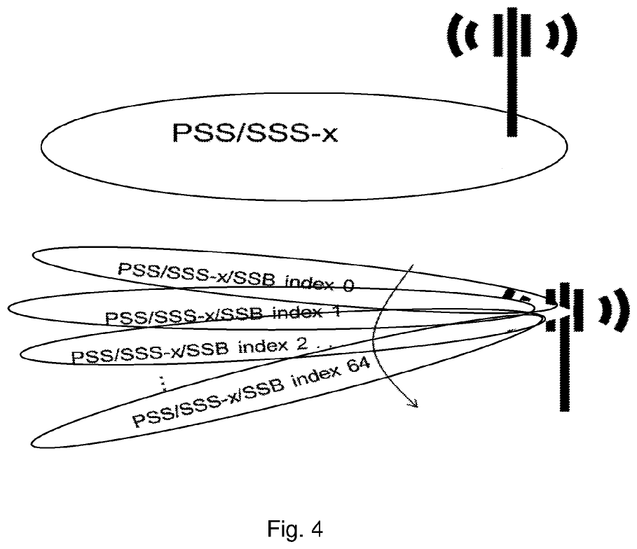

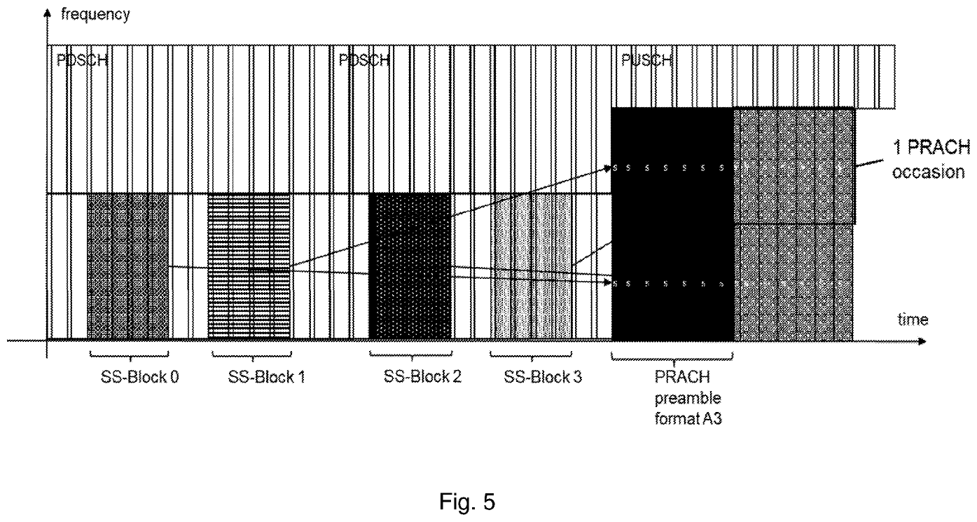

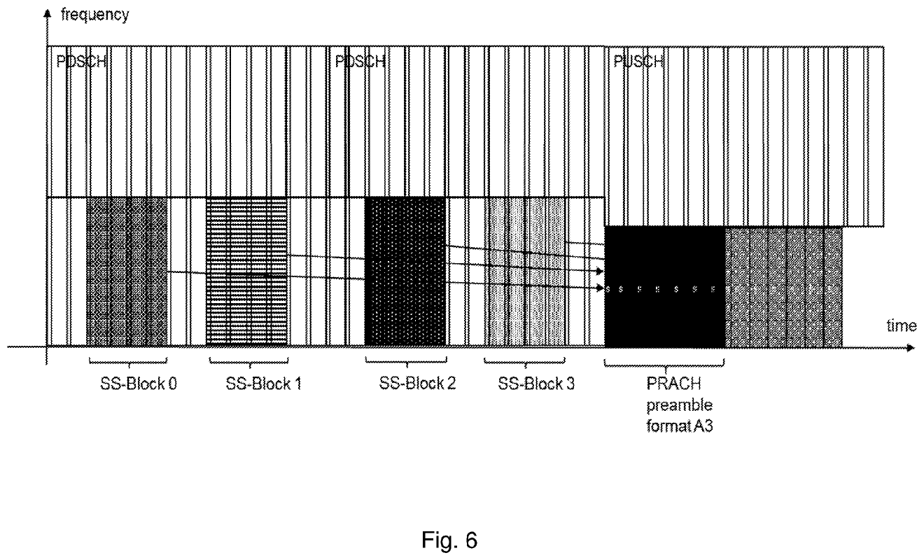

### DETAILED DESCRIPTION

Embodiments herein are described in the context of 5G/NR but the same concept can also be applied to other wireless communication system such as 4G/LTE. Embodiments herein may be described within the context of 3GPP NR radio technology (3GPP TS 38.300 V15.2.0 (2018-06)), e.g. using gNB as the radio network node. It is understood, that the problems and solutions described herein are equally applicable to wireless access networks and UEs implementing other access technologies and standards. NR is used as an example technology where embodiments are suitable, and using NR in the description therefore is particularly useful for understanding the problem and solutions solving the problem. In particular, embodiments are applicable also to 3GPP LTE, or 3GPP LTE and NR integration, also denoted as non-standalone NR.

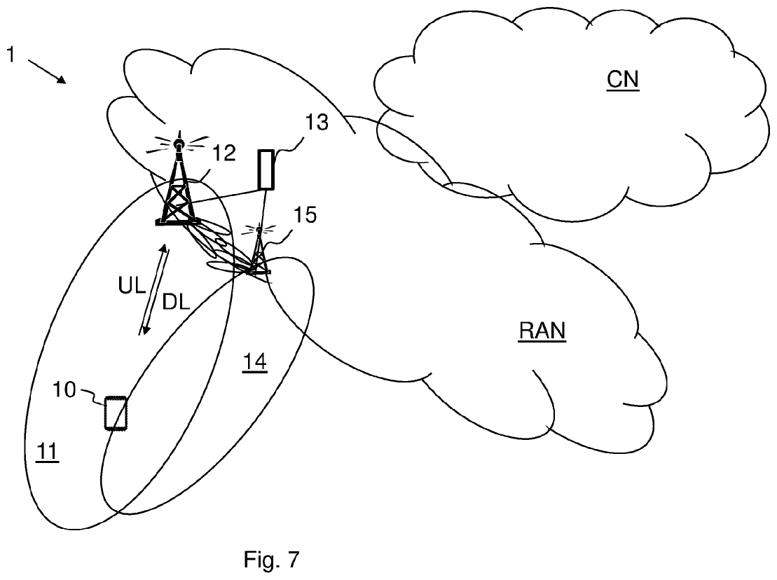

Embodiments herein relate to wireless communication networks in general. FIG. 7 is a schematic overview depicting a wireless communication network 1. The wireless communication network 1 comprises e.g. one or more RANs and one or more CNs. The wireless communication network 1 may use one or a number of different technologies, such as Wi-Fi, Long Term Evolution (LTE), LTE-Advanced, NR, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in 5G systems, however, embodiments are also applicable in further development of the existing communication systems such as e.g. a WCDMA or a LTE system.

In the wireless communication network 1, wireless devices e.g. a UE 10 such as a mobile station, a non-access point (non-AP) station (STA), a STA, a user equipment and/or a wireless terminal, communicate via one or more Access Networks (AN), e.g. RAN, to one or more core networks (CN). It should be understood by the skilled in the art that “UE” is a non-limiting term which means any terminal, wireless communication terminal, user equipment, Machine Type Communication (MTC) device, Device to Device (D2D) terminal, internet of things (IoT) operable device, or node e.g. smart phone, laptop, mobile phone, sensor, relay, mobile tablets or even a small base station capable of communicating using radio communication with a network node within an area served by the network node.

The communication network 1 comprises a first radio network node 12 providing e.g. radio coverage over a geographical area, a first service area 11 i.e. a first cell, of a radio access technology (RAT), such as NR, LTE, Wi-Fi, WiMAX or similar. The first radio network node 12 may be a transmission and reception point, a computational server, a base station e.g. a network node such as a satellite, a Wireless Local Area Network (WLAN) access point or an Access Point Station (AP STA), an access node, an access controller, a radio base station such as a NodeB, an evolved Node B (eNB, eNodeB), a gNodeB (gNB), a base transceiver station, a baseband unit, an Access Point Base Station, a base station router, a transmission arrangement of a radio base station, a stand-alone access point or any other network unit or node depending e.g. on the radio access technology and terminology used. The first radio network node 12 may alternatively or additionally be a controller node or a packet processing node or similar. The first radio network node 12 may be referred to as source access node or a serving network node wherein the first service area 11 may be referred to as a serving cell, source cell or primary cell, and the first radio network node communicates with the UE 10 in form of DL transmissions to the UE 10 and UL transmissions from the UE 10. The first radio network node may be a distributed node comprising a baseband unit and one or more remote radio units. The first radio network node 12 is herein exemplified as a distributed unit of base station such as a DU.

The communication network 1 comprises a second radio network node 13 of a radio access technology (RAT), such as NR, LTE, Wi-Fi, WiMAX or similar. The second radio network node 13 may be a central unit of a base station a so called CU, a transmission and reception point, a computational server, a base station e.g. a network node such as a satellite, a Wireless Local Area Network (WLAN) access point or an Access Point Station (AP STA), an access node, an access controller, a radio base station such as a NodeB, an evolved Node B (eNB, eNodeB), a gNodeB (gNB), a base transceiver station, a baseband unit, an Access Point Base Station, a base station router, a transmission arrangement of a radio base station, a stand-alone access point or any other network unit or node depending e.g. on the radio access technology and terminology used.

The communication network 1 comprises a third radio network node 15 providing e.g. radio coverage over the geographical area, a second service area 14 i.e. a second cell, of a radio access technology (RAT), such as NR, LTE, Wi-Fi, WiMAX or similar. The third radio network node 12 may be a transmission and reception point, a computational server, a base station e.g. a network node such as a satellite, a Wireless Local Area Network (WLAN) access point or an Access Point Station (AP STA), an access node, an access controller, a radio base station such as a NodeB, an evolved Node B (eNB, eNodeB), a gNodeB (gNB), a base transceiver station, a baseband unit, an Access Point Base Station, a base station router, a transmission arrangement of a radio base station, a stand-alone access point or any other network unit or node depending e.g. on the radio access technology and terminology used. The third radio network node 15 may be a DU of a same or different base station such as another DU, and/or another CU.

It should be noted that a service area may be denoted as cell, beam, beam group or similar to define an area of radio coverage. It should further be noted that the first and second cell may be provided by the same first radio network node 12.

According to embodiments herein to cover the whole serving area, multiple transmissions with narrow beams differently steered in time domain are performed at the first radio network node 12. The provision of multiple narrow coverage beams for this purpose is also called “beam sweeping”.

Embodiments herein relate to that the first radio network node 12 e.g. a first DU, upon detection of a RACH conflict for a served cell or beam from another cell or beam, changes an order of performing the beam sweep denoted as order of beam sweeping or beam sweeping order. This new changed order of beam sweeping may be indicated to the second radio network node 13, e.g. a CU. The second radio network node 13 performs a communication action based on the received indication, for example, initiates a request to allocate some resources either at the third or the first radio network node based on the received indication, and/or the second radio network node 13 indicates, in its turn, the changed order to a different radio network node, i.e. to the third radio network node 15, e.g. a second DU.

The proposed method by leveraging changes in the beam sweeping order allows a gNB-DU such as the first radio network node 12, to efficiently and autonomously resolve PRACH configuration conflict for the served cell potentially without any assistance from the gNB-CU such as the second radio network node 13, and without changing PRACH configuration. Hence there is no need to exchange all the PRACH configuration of all the neighbouring cells over network interfaces, e.g., over Xn and F1 interface, thus, resulting in a resource efficient solution.

In addition, exchanging beam sweeping order among the neighbouring nodes, may help the neighbouring cells to build up a more precise neighbouring relations not only taking into account the spatial location of the beams, but also the temporal location of the neighbouring beams. This information can be used for coverage optimization as well as inter cell interference optimization.

Embodiments herein relate to methods, for example in case of an NR, wherein the architecture taken into consideration is a split architecture between the second radio network node 13 such as a central unit, and the first radio network node such as a distributed unit, for example, where a gNB-CU hosts high layers such as RRC and where the gNB-DU hosts lower layers such as PHY, MAC and RLC. The methods described herein can be applied to any RAT that follows the same split architecture. For example, they can be applied to the E-UTRAN split architecture or to the E-UTRA split architecture (or CU-CU and CU-UP split architecture).

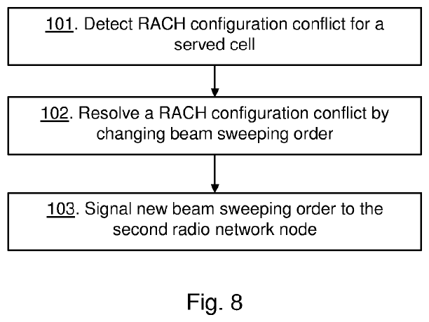

Embodiments herein relates to a method executed by the first radio network node 12 such as a gNB-DU, for resolving the RACH configuration of at least a served cell, see FIG. 8. The method may comprise:

Action 101: The first radio network node 12 may detect the RACH configuration conflict between the RACH configuration of the served cell 11 and the RACH configuration of a neighbouring cell 14, for example, same SSB in same time slot. The first radio network node 12 may detect or obtain an indication that a RACH configuration of a neighbouring cell is in conflict with the RACH configuration of the served cell. Embodiments herein may regard e.g. RACH conflict detection and resolution at the first radio network node 12 such as the DU. The first radio network node 12 may detect a (potential) RACH configuration conflict between the served cell and the neighbouring cell based on statistic information associated to failed random access attempts of UEs to the served cell. In one implementation, a random access attempt of the UE 10 is declared failed if the RACH msg-1 transmitted by the UE 10 is received by the first radio network node 12 according to the RACH configuration of the served cell, a RACH msg-2 is transmitted by the first radio network node 12 to the UE 10 to grant uplink resources to the UE for transmitting a RACH msg-3 according to the RACH configuration of the served cell, but the RACH msg-3 transmitted by the UE 10 is not received by the first radio network node 12 in the reserved resources.

Thus, the first radio network node 12 may detect a RACH configuration conflict.

The first radio network node 12 may, for instance, collect statistics associated to the number of failed RACH attempts, the frequency of the failed RACH attempts, the RACH resources wherein the RACH msg-1 is received from a UE during a failed RACH attempt, such as RACH preamble used, time-frequency location of the RACH msg-1 transmission, etc. The first radio network node 12 may then determine a RACH configuration conflict if, for instance, the number of failed RACH attempts exceeds a predefined threshold. In an alternative implementation, the first radio network node 12 may determine a RACH configuration conflict if the number of failed RACH attempts within a part of the RACH resources used by the served cell exceeds a predefined threshold. A part of the RACH resources could be defined, for instance, as the Random Access Resources associated by the serving cell with one or more SSB beams. This could comprise, for instance, the SSB beam sweeping pattern in time and/or frequency domain.

Action 102: The first radio network node 12 changes the beam sweeping order for the served cell 11 based on the detection of the RACH configuration conflict. The first radio network node 12 may change the beam sweeping order of the served cell 11 based on the detection of the RACH configuration conflict to resolve the RACH configuration conflict. Once the first radio network node 12 determines that a RACH configuration conflict has occurred, the first radio network node 12 may resolve the RACH configuration conflict via changing beam sweeping order. In fact, changing beam sweeping order will change the temporal location of the SSB beams and hence will potentially create orthogonality for RACH resources (that are configured equally among the neighbouring/conflicting cells) resolving the existing RACH conflict. When changing the PRACH configuration, the first radio network node 12 may take into account the PRACH configuration of neighbouring cells. For example, the hosting gNB-CU, for example, the second radio network node 12, may signal over the F1 interface a list of PRACH configurations already in use by neighbouring cells and the first radio network node 12 may take such information into account to select the appropriate new beam sweeping configuration, i.e. the new order of beam sweeping, that would resolve the RACH configuration conflict.

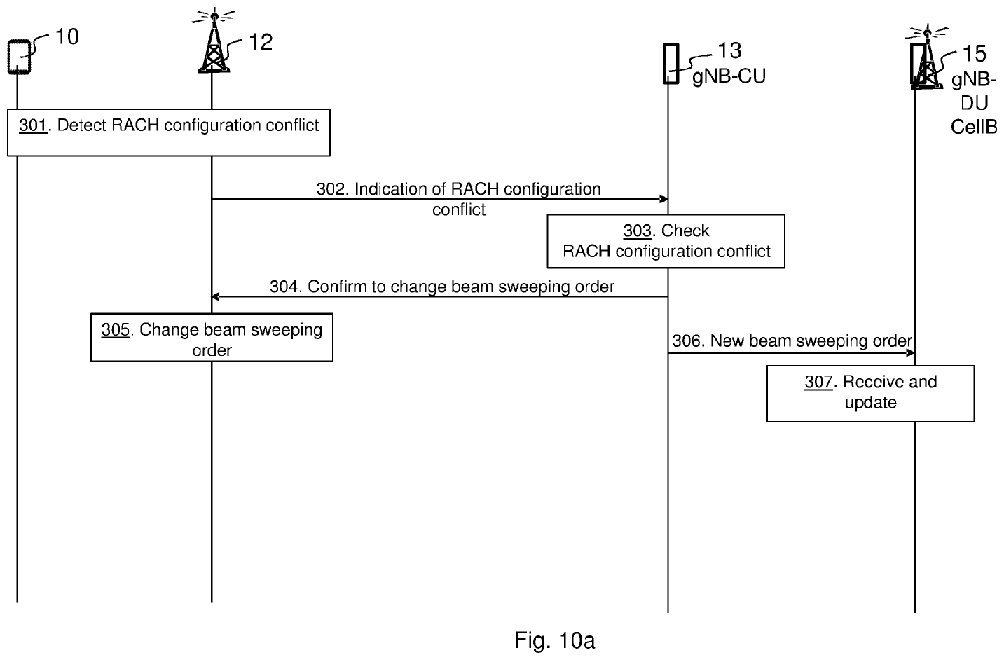

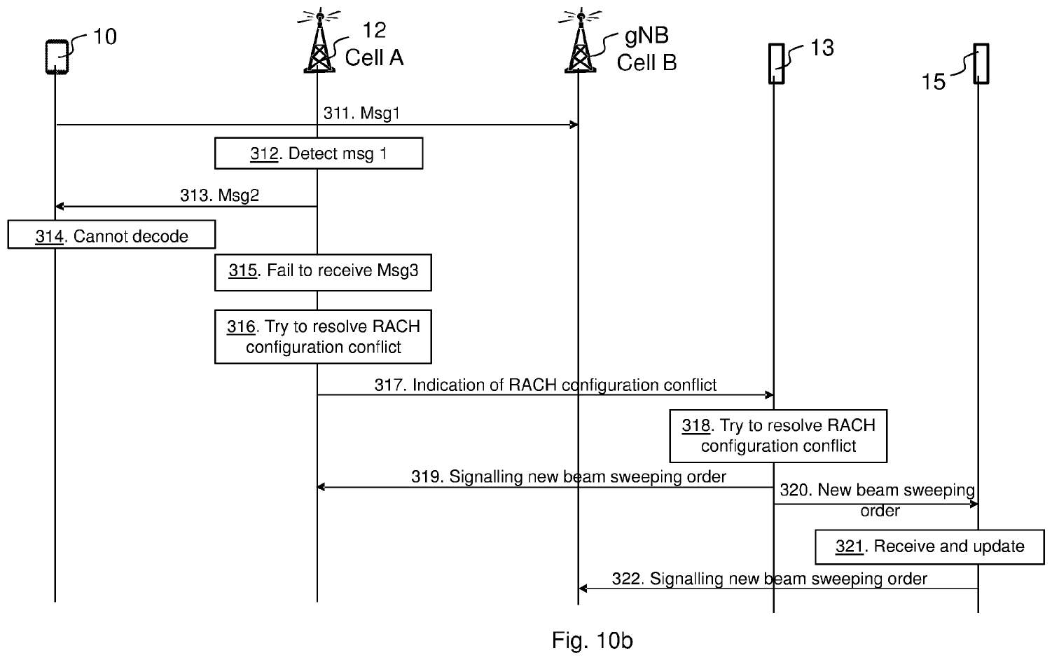

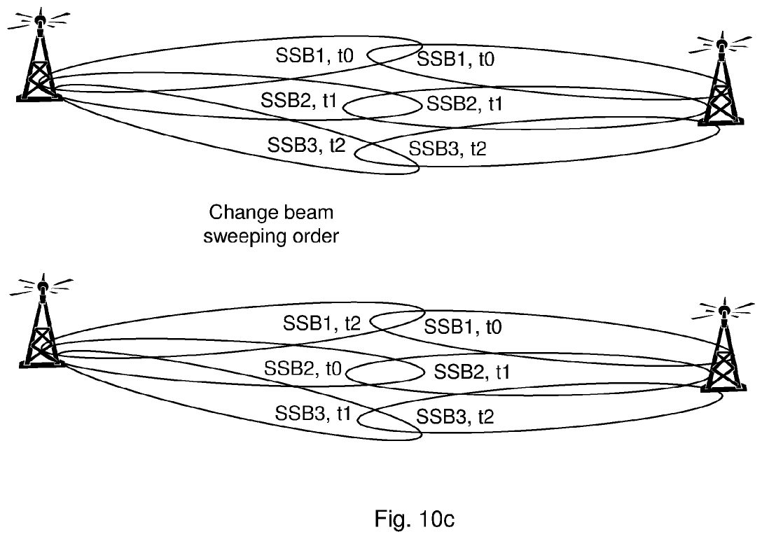

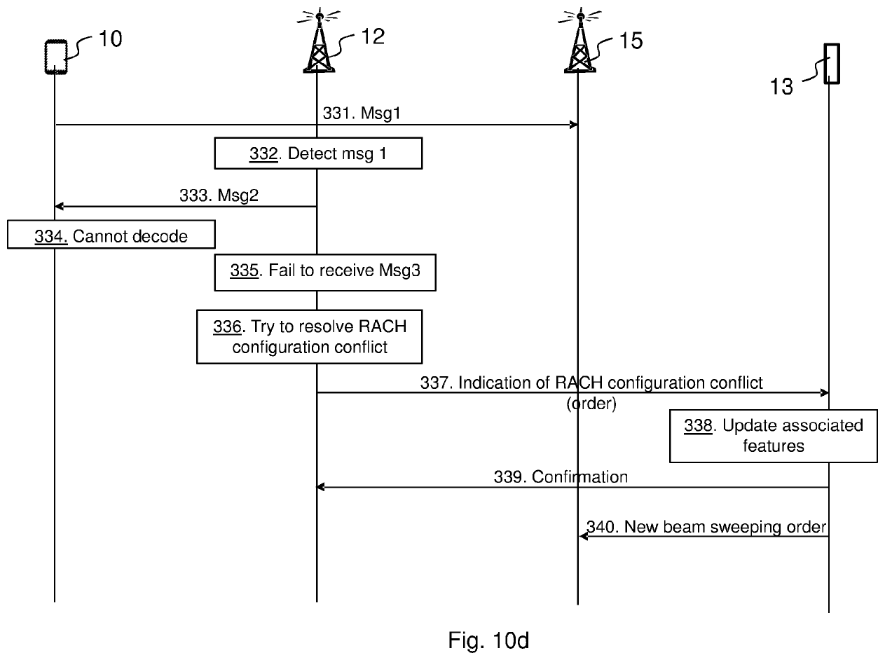

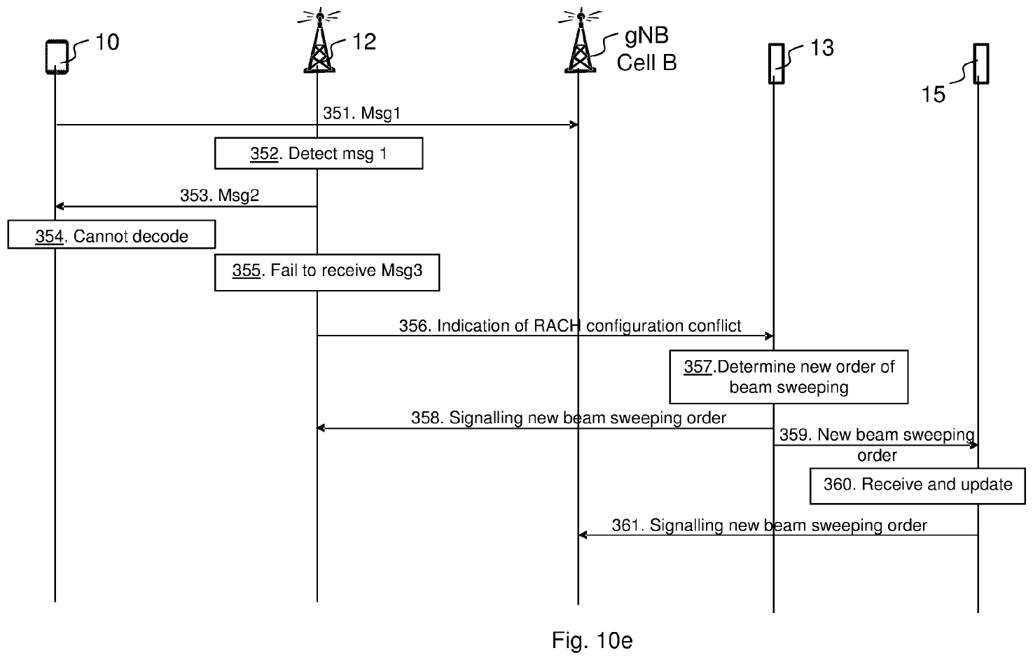

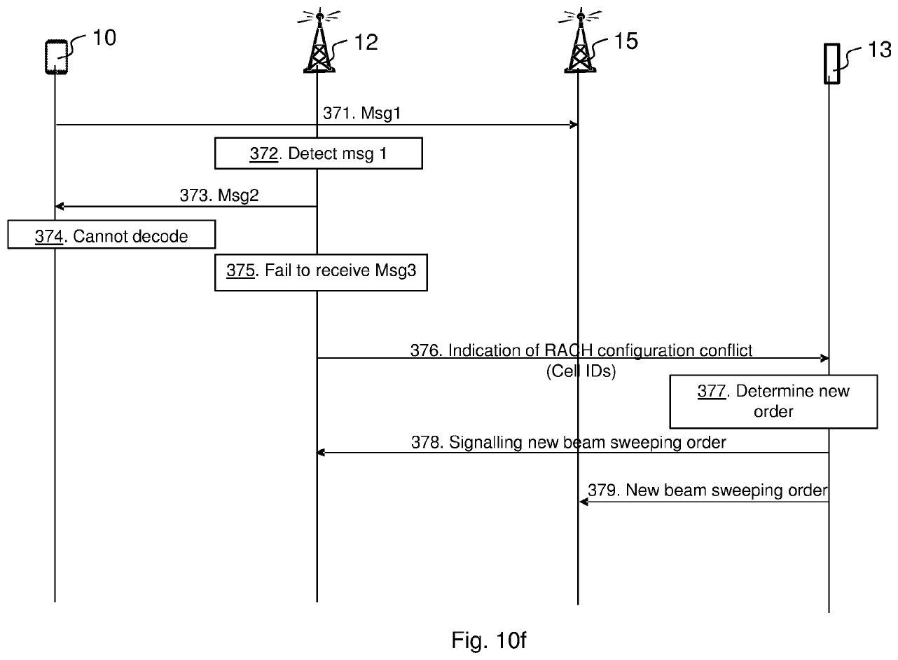

Action 103: The first radio network node 12 may signal the new beam sweeping order to the second radio network node 13 (e.g., a gNB-CU). Upon detection and resolution of RACH configuration conflict, as shown in action 301 in FIG. 10a, the first radio network node 12 may signal to the second radio network node 13 e.g. gNB-CU, an indication indicating the new beam sweeping configuration (beam sweeping order) of the cell A. Hence the second radio network node 13 would be able to perform a communication procedure such as transmit the new order of beam sweeping of the first radio network node 12 to the third radio network node 15, determine the new order, and/or update associated features affected by beam sweeping order such as beam relation, inter-cell interference cancelation as well as coverage optimization.
In one embodiment, signalling the indication of the beam sweeping order from gNB-DU to gNB-CU and/or other RAN nodes, may include the actual beam sweeping order including the beam indices or any identifier that can be used to unequivocally detect a beam in a given cell. E.g., [beam-1, beam-2, beam-3] indicates the beam sweeping order in a chronological order.
In another embodiment, beam sweeping orders (signaled from gNB-DU to the gNB-CU and other RAN nodes) may be mapped to indexes (similar to Active Antenna System configuration in LTE system), in which each index indicates one possible beam sweeping order that is universally known among all RAN nodes. E.g., sweeping index 1 indicates beam sweeping order as [beam-1, beam-2, beam-3], swept in a chronological order. Sweeping index 2 is associated to beam sweeping order as [beam-2, beam3, beam1], swept in a chronological order.
In yet another embodiment, the indication is a beam sweeping direction (clockwise or counterclockwise) that is signaled to the other RAN nodes,
In yet another embodiment, the indication may be a beam pointing angle/direction as well as beam width is signaled to the other RAN nodes.

In an embodiment, the first radio network node 12 may wait for a confirmation signal, received from the second radio network node 14 before applying the new configuration or order, as shown at step 304 in FIG. 10a. For example, the gNB-CU may acknowledge or not acknowledge the new configuration, on the basis of information related to PRACH configuration/beam sweeping order previously received from other neighbouring cells, e.g. the gNB-CU may reject the change if the new configuration the gNB-DU wants to apply is at least partially overlapping with the PRACH configuration/beam sweeping order already applied by the neighbouring cells.

In another embodiment, the gNB-CU may signal the beam sweeping order received from the gNB-DU (and maybe the new beam relations) to the other neighbouring gNB-CU owning the conflicting cell (in FIG. 10b Cell B of the gNB2). Among the multiple neighbouring cells, the gNB-CU selects the one or more conflicting cells on the basis of information related to PRACH configuration/beam sweeping order previously received from other neighbouring cells, i.e. the gNB-CU determines the neighbouring cells as conflicting if their PRACH configuration/beam sweeping order is at least partially overlapping with the PRACH configuration/beam sweeping order of the concerned cell. In another embodiment, e.g. in case the gNB-CU is not able to determine any conflicting cell, it inquiries gNB-CUs hosting neighbouring cells to provide PRACH configuration/beam sweeping order of the hosted cells. In yet another alternative, all the neighbouring gNB-CUs are informed about the new PRACH configuration/beam sweeping order.

Upon receiving the above information, the neighbouring gNB-CU may perform a communication action based on the received indication e.g. be able to update the associated features such as mobility towards the cell for which the beam sweeping order has been changed, beam relation, inter-cell interference cancellation as well as coverage optimization.

In yet another embodiment, the gNB-CU may signal to the neighbouring gNB-DU owning the conflicting cell (e.g., in FIG. 10a gNB2-DU owning cell B) indicating RACH conflict resolution action taken by the gNB1-DU. The signaled information may include beam sweeping order as well as other relevant information of the cell A owned by gNB1-DU. Hence, gNB2-DU would be aware of resolving RACH conflict and avoid unnecessary actions (to resolve the RACH configuration conflict).

Thus it is herein disclosed a method executed by the first radio network node (a gNB-DU) for resolving the RACH configuration of at least the served cell.

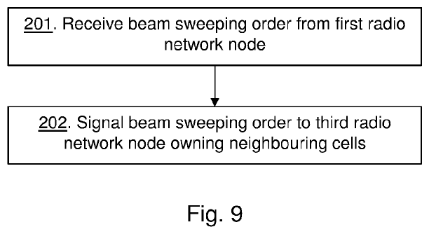

Embodiments herein disclose a method executed by the second radio network node 13 (i.e., a gNB-CU), see FIG. 9. The method may comprise:

Action 201. The second radio network node 13 receives a new beam sweeping order from the first radio network node 12, e.g., from a gNB-DU over the F1 interface, upon any change of beam sweeping order of the cell owned by the first radio network node 12.

Action 202. The second radio network node 13 may signal the new beam sweeping order to the third radio network node, e.g., another gNB-CU owning neighbouring cells e.g., over Xn or NG interface and/or a gNB-DU connected to the second network via an F1 interface.

FIG. 10a shows a combined signalling scheme and flowchart according to some embodiments herein.

Action 301. The first radio network node 12 may detect a possible RACH configuration conflict by, for example, detect failed RACH attempts by one or more UEs.

Action 302. The first radio network node 12 may further transmit an indication of a new order of beam sweeping, for example, an indication of RACH configuration conflict such as a request to resolve the RACH configuration conflict and/or bits defining the new order of beam sweeping.

Action 303. The second radio network node 13 may determine or check the new order of beam sweeping. For example, check if the order is used at a different neighbouring DU.

Action 304. The second radio network node 13 may then confirm the new order of beam sweeping back to the first radio network node 12.

Action 305. The first radio network node 13 then changes the order of beam sweeping, for example, upon confirmation or upon detection.

Action 306. Alternatively, or additionally, the second radio network node 13 may transmit the new order of beam sweeping to the third radio network node 15.

Action 307. The third radio network node 15 may then update associated features based on the received new order of beam sweeping of the first radio network node 12.

FIG. 10b shows an example of signalling exchange for RACH configuration conflict detection and resolution by changing beam sweeping order at gNB-DU.

A random access attempt of the UE 10 may be declared failed if: the RACH msg-1 transmitted by the UE 10, action 311, is received by the first radio network node 12, action 312, according to the RACH configuration of the served cell; a RACH msg-2 is transmitted by the first radio network node 12 to the UE 10, action 313, to grant uplink resources to the UE 10 for transmitting a RACH msg-3 according to the RACH configuration of the served cell; and the UE 10 cannot decode the msg2, action 314, and thus a RACH msg-3 is not received by the first radio network node 12 in the reserved resources, action 315. Thus, the first radio network node 12 may fail to receive Msg3 that prompts the first radio network node 12 to build up statistics for potential occurrence of RACH configuration conflict. The first radio network node 12 may try and resolve the issue by itself by changing the order of beam sweeping, action 316. The first radio network node may further transmit an indication of RACH configuration conflict to the second radio network node 13, action 317.

The second radio network node 13 receives the indication of RACH configuration conflict and may update associated features such as, beam relations, interference cancellations, and/or coverage optimization, action 318. The second radio network node 13 may then confirm the changed order of beam sweeping by sending a confirmation of changes in beam sweeping order to the first radio network node 12, action 319. The second radio network node 13 may additionally signal the new order of beam sweeping for the first cell, to the third radio network node 15, action 320.

The third radio network node 15 may receive the new order of beam sweeping of the first radio network node 12 and may update associated features such as beam relations, interference cancellation, and/or coverage optimization, action 321. The third radio network node 15 may then signal the updated order of beam sweeping to neighbouring cells, action 322.

FIG. 10c shows a schematic view of RACH conflict that is resolved by changing beam sweeping order. More precisely, it is shown that, when SSB1, SSB2 and SSB3 of cell A are swept at time t0, t1, and t2, there would be possibility of RACH conflict, if RACH configuration is equal in cell A and cell B. According to the designed solution, gNB1 owning cell A may change the beam sweeping order so that SSB1, SSB2 and SSB3 of cell A are swept at time t2, t0, and t1 (in other words new beam sweeping order will be SSB2, SSB3 and SSB1). Therefore, although beams SSB1, SSB2, and SSB3 of cell A are spatially neighbour with beams SSB1, SSB2, SSB3 of cell B, they will be temporally orthogonal and in a non-conflicting condition (even with equal RACH configuration). FIG. 10c shows a schematic view of RACH configuration conflict resolution by changing the beam sweeping order at gNB-DU.

While the example taken to describe embodiments herein is the one of an NG RAN system, it is obvious to the person skilled in the art that the techniques described apply to also other systems where a beam-based cell structure is adopted and where RACH resources availability have specific time and special patterns based on the beam structure of the cell. One other example where the proposed solutions may apply is the one of an E-UTRAN system where an en-gNB connects to an eNB and where communication of PRACH configurations for the en-gNB happens via the X2 interface towards the eNB.

In embodiments, the two cells with conflicting RACH configurations are owned by gNB-DUs, i.e. the first and third radio network node, connected to the same gNB-CU i.e. the second radio network node 13, as illustrated in FIG. 10d.

A random access attempt of the UE 10 may be declared failed if: the RACH msg-1 transmitted by the UE 10, action 331, is received by the first radio network node 12, action 332, according to the RACH configuration of the served cell; a RACH msg-2 is transmitted by the first radio network node 12 to the UE 10, action 333, to grant uplink resources to the UE 10 for transmitting a RACH msg-3 according to the RACH configuration of the served cell; and the UE 10 cannot decode the msg2, action 334, and thus a RACH msg-3 is not received by the first radio network node 12 in the reserved resources, action 335. Thus, the first radio network node 12 may fail to receive Msg3 that prompts the first radio network node 12 to build up statistics for potential occurrence of RACH configuration conflict. The first radio network node 12 may try and resolve the issue by itself by changing the order of beam sweeping, action 336. The first radio network node may further transmit an indication of RACH configuration conflict to the second radio network node 13, action 337. For example, the first radio network node may transmit the changed order of beam sweeping.

The second radio network node 13 receives the new order of beam sweeping and may update associated features such as, beam relations, interference cancellations, and/or coverage optimization, action 338. The second radio network node 13 may then confirm the changed order of beam sweeping by sending a confirmation of changes in beam sweeping order to the first radio network node 12, action 339. In this case, upon receiving an updated beam sweeping patter i.e. the new order from one of the gNB-DUs, the gNB-CU may signal the new beam sweeping order (and maybe the new beam relations) to a second gNB-DU, i.e. the third radio network node 15, owning the conflicting cell see action 340. Therefore, the second gNB-DU would be able to update the associated features such as beam relation, inter-cell interference cancellation as well as coverage optimization. FIG. 10d shows an example of signalling exchange for RACH configuration conflict detection and resolution by changing beam sweeping order at gNB-DU when conflict occurs between cells belonging to the same gNB-CU. The gNB-CU may signal to the second gNB-DU2 owning the conflicting cell, e.g., in FIG. 10d gNB-DU2 owning cell B, indicating RACH conflict resolution action taken by the first gNB-DU1. The signaled information may include new beam sweeping order of the cell A owned by the first gNB-DU1. Hence, second gNB-DU2 would be aware of resolving RACH conflict and avoid unnecessary actions, to resolve the RACH configuration conflict.

RACH conflict detection at gNB-DU and resolution at gNB-CU.

Upon detection of RACH configuration conflict, as shown in action 301 in FIG. 10a, the first radio network node 12 may signal to the second radio network node 13 indicating the RACH configuration conflict with the conflicting cells related information such as cell identity as well as beam sweeping order if not available at gNB-CU. This signal is a request to resolve RACH configuration conflict at the second radio network node 13 possibly by changing order of beam sweeping. The second radio network node 13 can then determine a new order of beam sweeping for the cell controlled by the first radio network node 12 in such a way to resolve the RACH configuration conflict and updates the associated features affected by beam sweeping order such as beam relation, inter-cell interference cancellation as well as coverage optimization. This operation may be done by the second radio network node 13 taking into account information previously received from the third radio network node 15 such as a neighbouring gNB-CU, i.e. excluding PRACH resources and related beam sweeping order already in use by neighbouring cells.

Alternatively, the second radio network node 13 may signal to the first radio network node 12 to select a new beam sweeping order. The second radio network node 13 may also signal information about PRACH configurations of neighbour cells of the cell in RACH configuration conflict. This latter would allow the first radio network node 12 to take a more precise decision on the type of new beam sweeping order to select to resolve the RACH configuration conflict. Alternatively, if no neighbour cell information is provided to the first radio network node 12, the first radio network node 12 may trigger a self-determined change of beam sweeping order. If a RACH configuration conflict still persists the procedure between the second radio network node 13 and the first radio network node 12 can be re-iterated.

In addition, the second radio network node 13 may determine a time at which (or after which) the first radio network node 12 may apply the new beam sweeping order to the served cell 11 for which the RACH configuration conflict was detected. Postponing the resolution of the RACH conflict at the first radio network node 12 may be necessary to allow the second radio network node 13 to coordinate with the neighbouring gNB-CU, i.e. third radio network node 15, hosting the conflicting cell about the new beam sweeping order determined to resolve the RACH configuration conflict. In one example, the second radio network node 13 may transmit to the neighbouring third radio network node 15 hosting the conflicting cell a message comprising the information associated to RACH conflict resolution, such as the new beam sweeping order determined to resolve the RACH configuration conflict. In another example, the first radio network node 12 may wait to receive a confirmation message associated to RACH conflict resolution from the neighbouring third radio network node 15, gNB-CU, hosting the conflicting cell.

FIG. 10e shows an example of signalling exchange for RACH configuration conflict detection and resolution by changing beam sweeping order at gNB-CU.

A random access attempt of the UE 10 may be declared failed if: the RACH msg-1 transmitted by the UE 10, action 351, is received by the first radio network node 12, action 352, according to the RACH configuration of the served cell; a RACH msg-2 is transmitted by the first radio network node 12 to the UE 10, action 353, to grant uplink resources to the UE 10 for transmitting a RACH msg-3 according to the RACH configuration of the served cell; and the UE 10 cannot decode the msg2, action 354, and thus a RACH msg-3 is not received by the first radio network node 12 in the reserved resources, action 355. Thus, the first radio network node 12 may fail to receive Msg3 that prompts the first radio network node 12 to build up statistics for potential occurrence of RACH configuration conflict. The first radio network node may further transmit an indication of RACH configuration conflict to the second radio network node 13, action 356.

The second radio network node 13 may then determine, action 357, a new order of beam sweeping for the cell controlled by the first radio network node 12 in such a way to resolve the RACH configuration conflict and updates the associated features affected by beam sweeping order such as beam relation, inter-cell interference cancellation as well as coverage optimization. This operation may be done by the second radio network node 13 taking into account information previously received from the third radio network node such as a neighbouring gNB-CU, i.e. excluding PRACH resources and related beam sweeping order already in use by neighbouring cells.

As shown in action 358 of FIG. 10e, the second radio 13 signals the new beam sweeping order to the first radio network node 12, resolving RACH configuration conflict. The first radio network node 12 may then apply the new beam sweeping order to the cell for which a conflict was detected either once the new beam sweeping order is received from the second radio network node 13. In alternative, the first radio network node 12 may postpone the application of the new beam sweeping order to a time when the beam cell load is low with least RRC-connected UEs. In another example, the first radio network node 12 postpones the application of the new beam sweeping order to a time or after a time indicated by the second radio network node 13.

In another embodiment, as shown in action 359 of FIG. 10e, the second radio network node 13 signals the new beam sweeping order to the third radio network node 15 e.g. other gNB-CUs owning the neighbouring cells. Hence, the other gNB-CUs can update their beam relation with the conflicting cells or Inter-Cell Interference Coordination (ICIC) policies as well as coverage optimization parameters, action 360.

In yet another embodiment, as shown at action 361 in FIG. 10e, the gNB-CU may signal to the neighbouring gNB-CU, owning the conflicting cell, e.g., in FIG. 10e gNB2-DU owning cell B, indicating RACH conflict resolution action taken by the gNB1-DU. The signaled information may include new beam sweeping order as well as other relevant information of the cell A owned by gNB1-DU. Hence, gNB2-DU would be aware of resolving RACH conflict and avoid unnecessary actions (to resolve the RACH configuration conflict).

The two cells with conflicting RACH configurations may be owned by gNB-DUs connected to the same gNB-CU, as illustrated in FIG. 10f. A random access attempt of the UE 10 may be declared failed if: the RACH msg-1 transmitted by the UE 10, action 371, is received by the first radio network node 12, action 372, according to the RACH configuration of the served cell; a RACH msg-2 is transmitted by the first radio network node 12 to the UE 10, action 373, to grant uplink resources to the UE 10 for transmitting a RACH msg-3 according to the RACH configuration of the served cell; and the UE 10 cannot decode the msg2, action 374, and thus a RACH msg-3 is not received by the first radio network node 12 in the reserved resources, action 375. Thus, the first radio network node 12 may fail to receive Msg3 that prompts the first radio network node 12 to build up statistics for potential occurrence of RACH configuration conflict. The first radio network node 12 may further transmit an indication of RACH configuration conflict to the second radio network node 13, action 376. For example, the first radio network node 12 may transmit with a request for resolving the RACH configuration conflict for example with the conflicting cells related information such as cell identity as well as beam sweeping order if not available at the second radio network node 13.

The second radio network node 13 may then determine, action 377, the new order of beam sweeping for the cell controlled by the first radio network node 12 in such a way to resolve the RACH configuration conflict and updates the associated features affected by beam sweeping order such as beam relation, inter-cell interference cancellation as well as coverage optimization. This operation may be done by the second radio network node 13 taking into account information previously received from the third radio network node such as a neighbouring gNB-CU, i.e. excluding PRACH resources and related beam sweeping order already in use by neighbouring cells.

In this case, upon changing beam sweeping pattern for one of the gNB-DUs, upon request from the first radio network node 12 see action 378, the second radio network node 13 may signal the new beam sweeping order (and maybe the new beam relations) to the second gNB-DU, i.e. the third radio network node, action 379, owning the conflicting cell. Therefore, the second gNB-DU would be able to update the associated features such as beam relation, inter-cell interference cancellation as well as coverage optimization. FIG. 10f shows an example of signalling exchange for RACH configuration conflict detection and resolution by changing beam sweeping order at the second radio network node 13 when conflicting cells belong to the same gNB-CU.

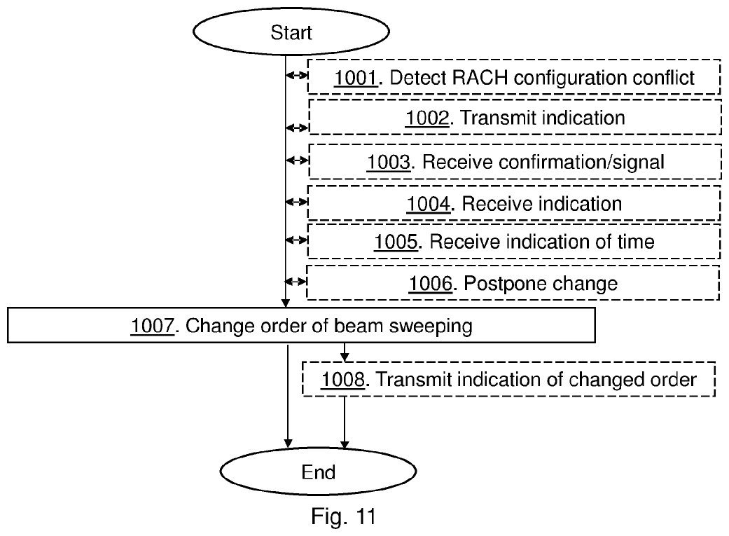

Embodiments herein relates to a method executed by the first radio network node 12 (e.g., a gNB-DU) for handling communication in the wireless communication network, for example, for resolving the RACH configuration of at least a served cell, see FIG. 11. The first radio network node may be a distributed unit and the second radio network node may be a central unit. The method comprising:

Action 1001: The first radio network node 12 may detect the RACH configuration conflict between the RACH configuration of a served cell and the RACH configuration of a neighbouring cell, for example, based on statistic information associated to failed random access attempts of UEs to the served cell.

Action 1002: The first radio network node 12 may transmit to the second radio network node, the indication of the new order of beam sweeping for the served cell of the first radio network node 12. The indication may be the request to resolve the RACH configuration conflict at the second radio network node 13 possibly by changing order of beam sweeping, or defines the new order of beam sweeping for a served cell of the first radio network node.

Action 1003: The first radio network node 12 may receive a signal from the second radio network node 13 to select a new order of beam sweeping and/or the confirmation from the second radio network node 13 to change to the new order of beam sweeping. The first radio network node 12 may receive indication from the second radio network node, indicating the RACH configuration conflict with conflicting cells related information.

Action 1004: The first radio network node 12 may receive from the second radio network node 13, the indication of the new order of beam sweeping.

Action 1005: The first radio network node 12 may receive from the second radio network node 13 the indication of the time when to apply the new order of beam sweeping.

Action 1006: The first radio network node 12 may postpone to change the order of beam sweeping to a time.

Action 1007: The first radio network node 12 changes the order of beam sweeping for the served cell based on the detection of the RACH configuration conflict. The first radio network node 12 may change the beam sweeping order of the served cell based on the detection of the RACH configuration conflict to resolve the RACH configuration conflict. Once the first radio network node 12 determines that a RACH configuration conflict has occurred, the first radio network node 12 may resolve the RACH configuration conflict via changing beam sweeping order. The first radio network node 12 may change the order of beam sweeping to the received new order of beam sweeping. PRACH configurations of neighbouring cells may be taken into account when changing the order of beam sweeping.

Action 1008: The first radio network node 12 may signal the new beam sweeping order to the second radio network node 13 (e.g., a gNB-CU). Upon detection and resolution of RACH configuration conflict, as shown in action 317 in FIG. 10b, the first radio network node 12 may signal to the second radio network node 13 e.g. gNB-CU the new beam sweeping configuration (beam sweeping order) of the cell A. Hence gNB-CU would be able to update associated features affected by beam sweeping order such as beam relation, inter-cell interference cancelation as well as coverage optimization.

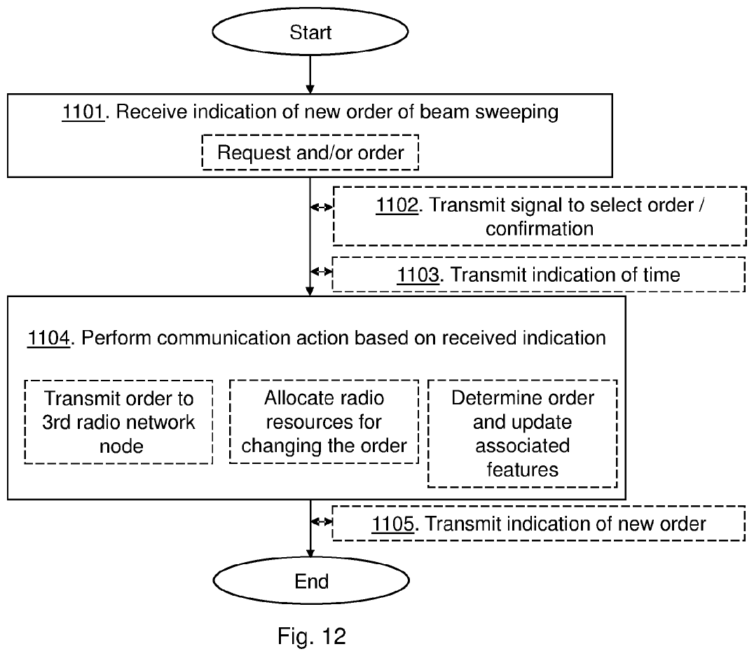

Embodiments herein disclose a method executed by the second network node 13 (i.e., a gNB-CU) for handling communication in the wireless communication network see FIG. 12. The first radio network node may be a distributed unit and the second radio network node may be a central unit. The method comprising:

Action 1101. The second radio network node 13 receives from the first radio network node 12, the indication of the new order of beam sweeping for the served cell of the first radio network node 12, e.g., from a gNB-DU over the F1 interface, upon any change of beam sweeping order of a cell owned by the first radio network node 12. The indication may be the request to resolve the RACH configuration conflict at the second radio network node 13 possibly by changing order of beam sweeping, or may define the new order of beam sweeping for the served cell of the first radio network node.

Action 1102. The second radio network node 13 may transmit the signal to the first radio network node 12 to select the new order of beam sweeping, and/or the confirmation back to the first radio network node 12 to change to the new order of beam sweeping.

Action 1103. The second radio network node 13 may transmit to the first radio network node an indication of the time when to apply the new order of beam sweeping.

Action 1104. The second radio network node 13 performs a communication action based on the received indication. For example the second radio network node 13 may signal the new beam sweeping order to the third radio network node, e.g., another gNB-CU owning neighbouring cells e.g., over Xn or NG interface or a gNB-DU connected to the second network via an F1 interface, and/or the second radio network node may perform a communication action based on the received indication. Thus, the second radio network node 13 may transmit the new order of beam sweeping to the third radio network node owning a cell conflicting with the served cell of the first radio network node. Alternatively, or additionally, the second radio network node 13 may allocate radio resources to the first radio network node 12 for changing to the new order of beam sweeping. Alternatively, or additionally, the second radio network node 13 may determine the new order of beam sweeping for the cell controlled by the first radio network node 12 to resolve the RACH configuration conflict and may update the associated features affected by beam sweeping order comprising beam relation, inter-cell interference cancelation, and/or coverage optimization.

Action 1105. The second radio network node 13 may transmit to the first radio network node the indication of the new order of beam sweeping.

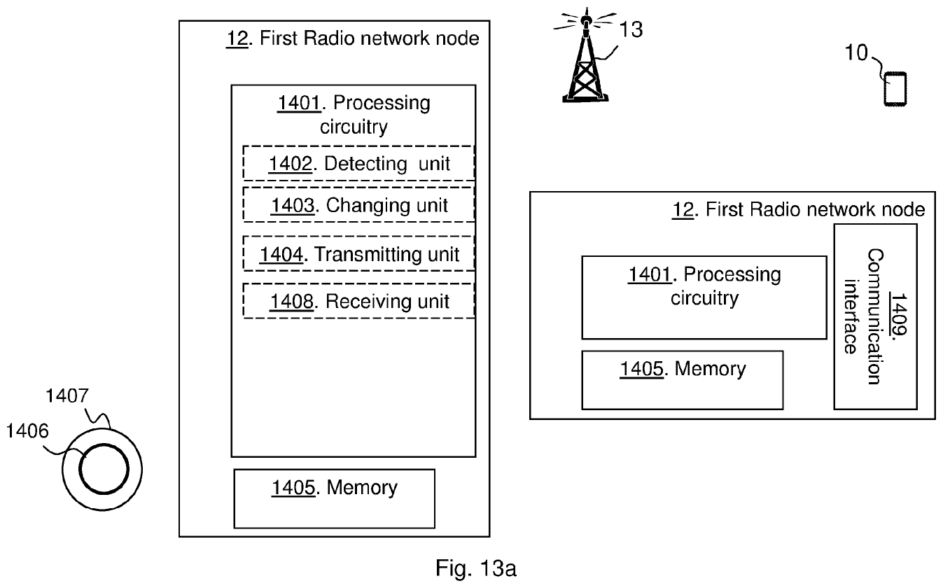

FIG. 13a is a block diagram depicting the first radio network node 12, in two embodiments, for handling communication, e.g. handling, enabling or performing communication or access to the radio network node, in the wireless communication network 1 according to embodiments herein. The first radio network node may be a distributed unit and the second radio network node may be a central unit.

The first radio network node 12 may comprise processing circuitry 1401, e.g. one or more processors, configured to perform the methods herein.

The first radio network node 12 may comprise a detecting unit 1402. The first radio network node 12, the processing circuitry 1401 and/or the detecting unit 1402 may be configured to detect the RACH configuration conflict between the served cell and the neighbouring cell based on statistic information associated to failed random access attempts of UEs to the served cell. Thus, the first radio network node 12 may detect the RACH configuration conflict between the RACH configuration of the served cell and the RACH configuration of the neighbouring cell. The first radio network node 12, the processing circuitry 1401 and/or the detecting unit 1402 may be configured to receive the indication from the second radio network node, indicating the RACH configuration conflict with conflicting cells related information.

The first radio network node 12 may comprise a changing unit 1403. The first radio network node 12, the processing circuitry 1401 and/or the changing unit 1403 is configured to change the order of beam sweeping or the beam sweeping order for the served cell based on the detection of the RACH configuration conflict. The first radio network node 12, the processing circuitry 1401 and/or the changing unit 1403 may be configured to take PRACH configurations of neighbouring cells into account when changing the order of beam sweeping. The first radio network node 12, the processing circuitry 1401 and/or the changing unit 1403 may be configured to postpone to change the order of beam sweeping to a time.

The first radio network node 12 may comprise a transmitting unit 1404, e.g. a transmitter or transceiver. The first radio network node 12, the processing circuitry 1401 and/or the transmitting unit 1404 may be configured to transmit to the second radio network node, the indication of the new order of beam sweeping for the served cell of the first radio network node 12. The indication may be the request to resolve the RACH configuration conflict at the second radio network node possibly by changing order of beam sweeping, or may define a new order of beam sweeping for the served cell of the first radio network node 12.

The first radio network node 12 may comprise a receiving unit 1408, e.g. a receiver or transceiver. The first radio network node 12, the processing circuitry 1401 and/or the receiving unit 1408 may be configured to receive from the second radio network node, the indication of the new order of beam sweeping and wherein the first radio network node, the processing circuitry 1401 and/or the changing unit 1403 is configured to change the order of beam sweeping order to the new order of beam sweeping. The first radio network node 12, the processing circuitry 1401 and/or the receiving unit 1408 may be configured to receive the signal from the second radio network node to select the new order of beam sweeping and/or the confirmation from the second radio network node to change to the new order of beam sweeping. The first radio network node 12, the processing circuitry 1401 and/or the receiving unit 1408 may be configured to receive from the second radio network node the indication of the time when to apply the new order of beam sweeping. The first radio network node 12, the processing circuitry 1401 and/or the receiving unit 1408 may be configured to receive the indication from the second radio network node, indicating the RACH configuration conflict with conflicting cells related information.

The first radio network node 12 further comprises a memory 1405. The memory comprises one or more units to be used to store data on, such as indications, strengths or qualities, RACH configurations, orders of beam sweeping, grants, messages, execution conditions, user data, reconfiguration, configurations, scheduling information, timers, applications to perform the methods disclosed herein when being executed, and similar. The first radio network node 12 comprises a communication interface 1409 comprising transmitter, receiver, transceiver and/or one or more antennas. Thus, it is herein disclosed a first radio network node for handling communication in the wireless communication network, wherein the first radio network node comprises processing circuitry and a memory, said memory comprising instructions executable by said processing circuitry whereby said first radio network node is operative to perform the method disclosed herein.

The methods according to the embodiments described herein for the first radio network node 12 are respectively implemented by means of e.g. a computer program product 1406 or a computer program product, comprising instructions, i.e., software code portions, which, when executed on at least one processor, cause the at least one processor to carry out the actions described herein, as performed by the first radio network node 12. The computer program product 1406 may be stored on a computer-readable storage medium 1407, e.g. a universal serial bus (USB) stick, a disc or similar. The computer-readable storage medium 1407, having stored thereon the computer program product, may comprise the instructions which, when executed on at least one processor, cause the at least one processor to carry out the actions described herein, as performed by the first radio network node 12. In some embodiments, the computer-readable storage medium may be a non-transitory or transitory computer-readable storage medium.

FIG. 13b is a block diagram depicting the second radio network node 13 such as a Central unit for handling communication, e.g. handling, enabling or performing communication or access to the radio network node, in the wireless communication network 1 according to embodiments herein.

The second radio network node 13 may comprise processing circuitry 1601, e.g. one or more processors, configured to perform the methods herein.

The second radio network node 13 may comprise a receiving unit 1602, e.g. a receiver or a transceiver. The second radio network node 13, the processing circuitry 1601 and/or the receiving unit 1602 is configured to receive, from a first radio network node, an indication of a new order of beam sweeping for a served cell of the first radio network node e.g. receive, from the first radio network node 12 serving the UE 10 in the first cell, the indication of the changed order of beam sweeping. The indication may be the request to resolve the RACH configuration conflict at the second radio network node possibly by changing order of beam sweeping, or may define the new order of beam sweeping for a served cell of the first radio network node

The second radio network node 13 may comprise a performing unit 1603. The second radio network node 13, the processing circuitry 1601 and/or the performing unit 1603 is configured to perform the communication action based on the received indication.

The second radio network node 13 may comprise a transmitting unit 1604, e.g. a transmitter or a transceiver. The second radio network node 13, the processing circuitry 1601 and/or the transmitting unit 1604 may be configured to transmit the new order of beam sweeping to the third radio network node owning a cell conflicting with the served cell of the first radio network node, e.g. transmit the new beam sweeping order to the third radio network node. The second radio network node 13, the processing circuitry 1601 and/or the performing unit 1603 may configured to perform the communication action by allocating radio resources to the first radio network node for changing to the new order of beam sweeping. The second radio network node 13, the processing circuitry 1601 and/or the performing unit 1603 may configured to perform the communication action by determining the new order of beam sweeping for the cell controlled by the first radio network node to resolve the RACH configuration conflict and updating the associated features affected by beam sweeping order comprising beam relation, inter-cell interference cancelation, and/or coverage optimization. The second radio network node 13, the processing circuitry 1601 and/or the transmitting unit 1604 may be configured to transmit to the first radio network node the indication of the new order of beam sweeping. The second radio network node 13, the processing circuitry 1601 and/or the transmitting unit 1604 may be configured to transmit the signal to the first radio network node to select the new order of beam sweeping, and/or the confirmation back to the first radio network node to change to the new order of beam sweeping. The second radio network node 13, the processing circuitry 1601 and/or the transmitting unit 1604 may be configured to transmit to the first radio network node an indication of a time when to apply the new order of beam sweeping.

The second radio network node further comprises a memory 1605. The memory comprises one or more units to be used to store data on, such as indications, strengths or qualities, orders of beam sweeping (i.e. beam sweeping configurations), grants, indications, reconfiguration, configuration, values, scheduling information, timers, applications to perform the methods disclosed herein when being executed, and similar. The second radio network node comprises a communication interface 1608 comprising transmitter, receiver, transceiver and/or one or more antennas. 1. Thus, it is herein disclosed a second radio network node for handling communication in the wireless communication network, wherein the second radio network node comprises processing circuitry and a memory, said memory comprising instructions executable by said processing circuitry whereby said second radio network node is operative to perform the method disclosed herein.

The methods according to the embodiments described herein for the second radio network node 13 are respectively implemented by means of e.g. a computer program product 1606 or a computer program product, comprising instructions, i.e., software code portions, which, when executed on at least one processor, cause the at least one processor to carry out the actions described herein, as performed by the second radio network node. The computer program product 1606 may be stored on a computer-readable storage medium 1607, e.g. a universal serial bus (USB) stick, a disc or similar. The computer-readable storage medium 1607, having stored thereon the computer program product, may comprise the instructions which, when executed on at least one processor, cause the at least one processor to carry out the actions described herein, as performed by the second radio network node. In some embodiments, the computer-readable storage medium may be a non-transitory or transitory computer-readable storage medium.

In some embodiments a more general term “radio network node” is used and it can correspond to any type of radio network node or any network node, which communicates with a wireless device and/or with another network node. Examples of network nodes are NodeB, Master eNB, Secondary eNB, a network node belonging to Master cell group (MCG) or Secondary Cell Group (SCG), base station (BS), multi-standard radio (MSR) radio node such as MSR BS, eNodeB, network controller, radio network controller (RNC), base station controller (BSC), relay, donor node controlling relay, base transceiver station (BTS), access point (AP), transmission points, transmission nodes, Remote Radio Unit (RRU), Remote Radio Head (RRH), nodes in distributed antenna system (DAS), core network node e.g. Mobility Switching Centre (MSC), Mobile Management Entity (MME) etc., Operation and Maintenance (O&M), Operation Support System (OSS), Self-Organizing Network (SON), positioning node e.g. Evolved Serving Mobile Location Centre (E-SMLC), Minimizing Drive Test (MDT) etc.

In some embodiments the non-limiting term wireless device or user equipment (UE) is used and it refers to any type of wireless device communicating with a network node and/or with another UE in a cellular or mobile communication system. Examples of UE are target device, device-to-device (D2D) UE, proximity capable UE (aka ProSe UE), machine type UE or UE capable of machine to machine (M2M) communication, PDA, PAD, Tablet, mobile terminals, smart phone, laptop embedded equipped (LEE), laptop mounted equipment (LME), USB dongles etc.

The embodiments are described for 5G. However the embodiments are applicable to any RAT or multi-RAT systems, where the UE receives and/or transmit signals (e.g. data) e.g. LTE, LTE FDD/TDD, WCDMA/HSPA, GSM/GERAN, Wi Fi, WLAN, CDMA2000 etc.

As will be readily understood by those familiar with communications design, that functions means or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of communications devices will appreciate the cost, performance, and maintenance trade-offs inherent in these design choices. Embodiments herein may configure the block error rate (BLER) target for a communication session between a network node and a UE.

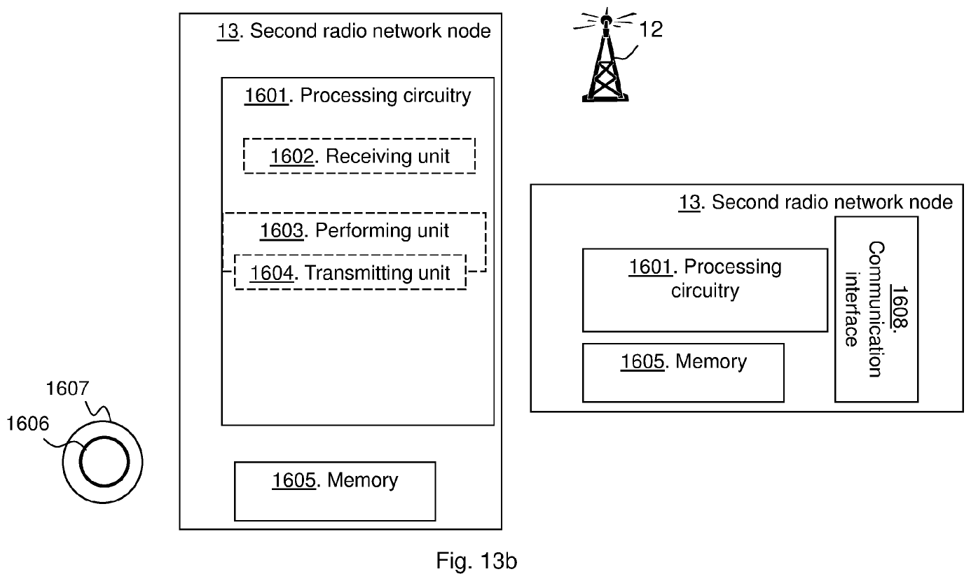

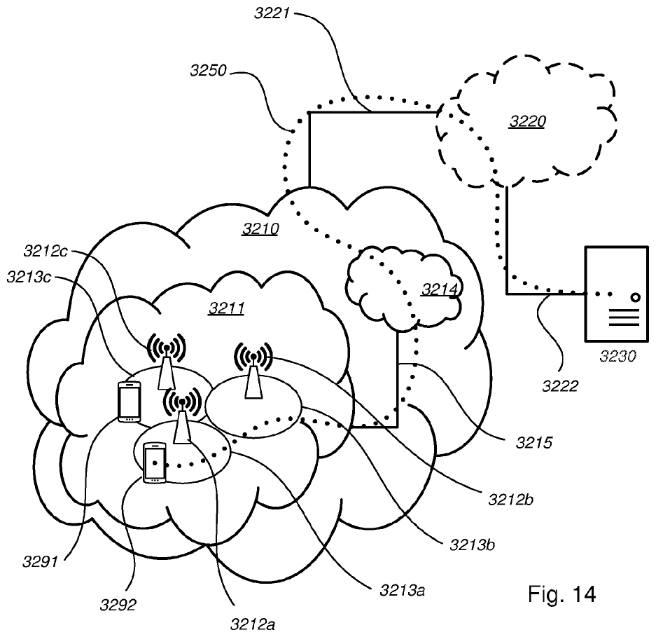

With reference to FIG. 14, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the radio network node 12 herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the UE 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 14 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signalling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

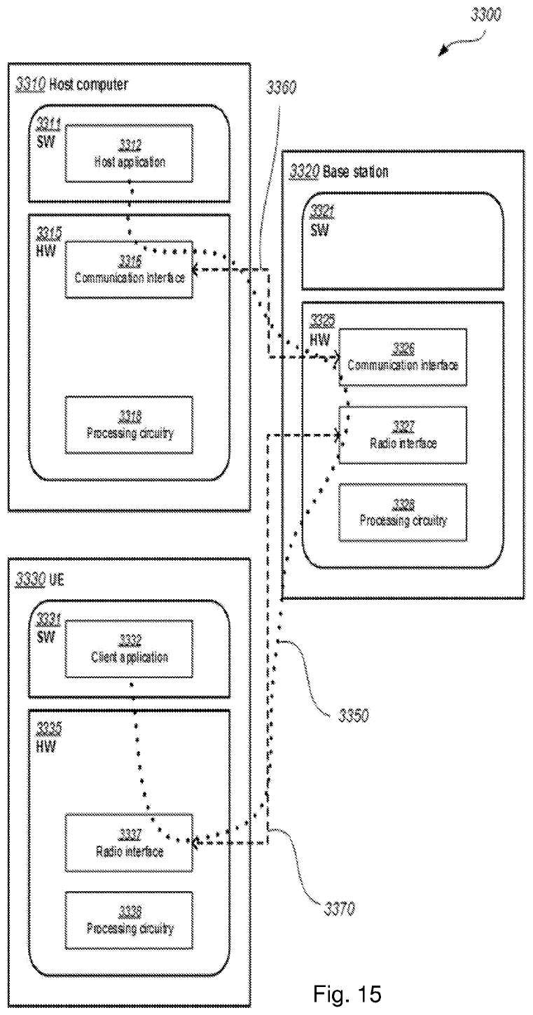

Example implementations, in accordance with an embodiment, of the UE, base station and host computer discussed in the preceding paragraphs will now be described with reference to FIG. 15. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 15) served by the base station 3320. The communication interface 3326 may be configured to facilitate a connection 3360 to the host computer 3310. The connection 3360 may be direct or it may pass through a core network (not shown in FIG. 15) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 15 may be identical to the host computer 3230, one of the base stations 3212a, 3212b, 3212c and one of the UEs 3291, 3292 of FIG. 14, respectively. This is to say, the inner workings of these entities may be as shown in FIG. 15 and independently, the surrounding network topology may be that of FIG. 14.

In FIG. 15, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may achieve an efficient RACH process resolving RACH configuration conflicts and thereby provide benefits such as improved battery time, and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signalling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

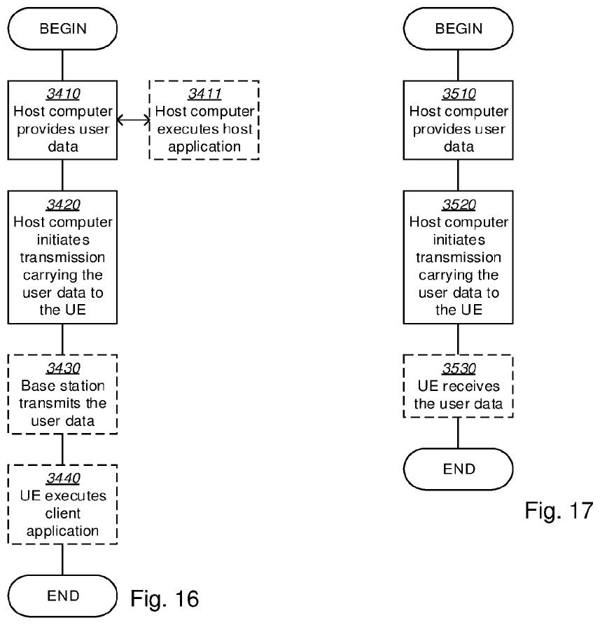

FIG. 16 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 16 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 17 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 17 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

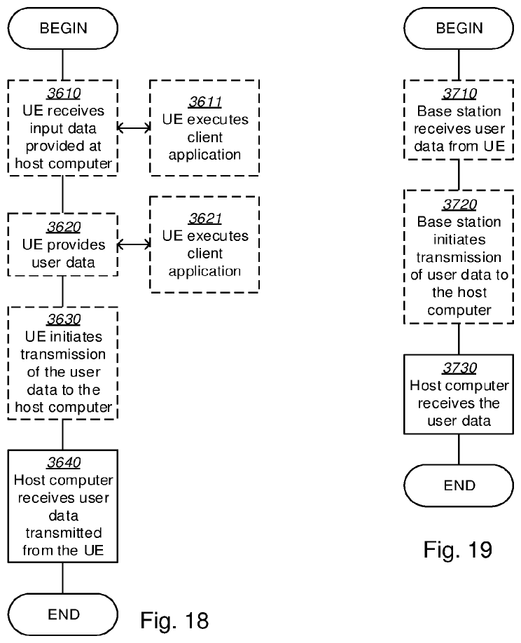

FIG. 18 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 18 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 19 is a flowchart illustrating a method implemented in a communication system, in accordance with one embodiment. The communication system includes a host computer, a base station and a UE which may be those described with reference to FIGS. 14 and 15. For simplicity of the present disclosure, only drawing references to FIG. 19 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1-42. (canceled)

43. A method performed by a first radio network node for handling communication in a wireless communication network, the method comprising
changing an order of beam sweeping for a served cell based on a detection of a random access channel (RACH) configuration conflict.

44. The method of claim 43, further comprising
sending, to a second radio network node, an indication of a new order of beam sweeping for the served cell of the first radio network node.

45. The method of claim 44, wherein the indication is a request to resolve the RACH configuration conflict at the second radio network node possibly by changing order of beam sweeping, or defines a new order of beam sweeping for a served cell of the first radio network node.

46. The method of claim 44, further comprising
receiving from the second radio network node, an indication of the new order of beam sweeping and wherein the first radio network node changes the order of beam sweeping order to the new order of beam sweeping.

47. The method of claim 43, wherein the first radio network node is a distributed unit and the second radio network node is a central unit.

48. The method of claim 43, further comprising
detecting the RACH configuration conflict between the served cell and the neighboring cell based on statistic information associated to failed random access attempts of user equipments (UEs) to the served cell.

49. The method of claim 43, further comprising
receiving a signal from the second radio network node to select a new order of beam sweeping and/or a confirmation from the second radio network node to change to the new order of beam sweeping.

50. The method of claim 43, wherein physical random access channel (PRACH) configurations of neighboring cells are taken into account when changing the order of beam sweeping.

51. The method of claim 43, further comprising
receiving from the second radio network node an indication of the time when to apply the new order of beam sweeping, and
postponing changing the order of beam sweeping to the indicated time.

52. The method of claim 43, further comprising
receiving an indication from a second radio network node, indicating the RACH configuration conflict with conflicting cells related information.

53. A method performed by a second radio network node for handling communication in a wireless communication network, the method comprising:
receiving, from a first radio network node, an indication of a new order of beam sweeping for a served cell of the first radio network node, and
performing a communication action based on the received indication.

54. The method of claim 53, wherein the indication is a request to resolve the RACH configuration conflict at the second radio network node possibly by changing order of beam sweeping, or defines the new order of beam sweeping for a served cell of the first radio network node.

55. The method of claim 53, wherein performing the communication action comprises:
transmitting the new order of beam sweeping to a third radio network node owning a cell conflicting with the served cell of the first radio network node.

56. The method of claim 53, wherein performing the communication action comprises:
allocating radio resources to the first radio network node for changing to the new order of beam sweeping.

57. The method of claim 53, wherein performing the communication action comprises:
determining the new order of beam sweeping for the cell controlled by the first radio network node to resolve the RACH configuration conflict and updating the associated features affected by beam sweeping order comprising beam relation, inter-cell interference cancelation, and/or coverage optimization.

58. The method of claim 57, further comprising:
sending to the first radio network node an indication of the new order of beam sweeping.

59. The method of claim 53, further comprising
sending a signal to the first radio network node to select a new order of beam sweeping, and/or a confirmation back to the first radio network node to change to the new order of beam sweeping.

60. The method of claim 53, further comprising:
sending to the first radio network node an indication of a time when to apply the new order of beam sweeping.

61. A first radio network node for handling communication in a wireless communication network, wherein the first radio network node comprises processing circuitry and a memory, said memory comprising instructions executable by said processing circuitry whereby said first radio network node is configured to:
change an order of beam sweeping for a served cell based on a detection of a random access channel (RACH) configuration conflict.

62. The first radio network node of claim 61, wherein the first radio network node is further configured to:
send, to a second radio network node, an indication of a new order of beam sweeping for the served cell of the first radio network node.

63. The first radio network node of claim 61, wherein the first radio network node is further configured to receive a signal from the second radio network node to select a new order of beam sweeping and/or a confirmation from the second radio network node to change to the new order of beam sweeping.

64. A second radio network node for handling communication in a wireless communication network, wherein the second radio network node comprises processing circuitry and a memory, said memory comprising instructions executable by said processing circuitry whereby said second radio network node is configured to:
receive, from a first radio network node, an indication of a new order of beam sweeping for a served cell of the first radio network node, and
perform a communication action based on the received indication.
